(19) United States
(12) Patent Application Publication
(10) Pub. No.: US 2025/0273772 A1
(43) Pub. Date: Aug. 28, 2025

(54) ELECTROCHEMICAL CELLS INCLUDING ELECTRODE STACKS FOR METAL-AIR BATTERIES

(71) Applicant: Form Energy, Inc., Somerville, MA (US)

(72) Inventors: Emily C. PITT, Boston, MA (US); Riley BRANDT, Somerville, MA (US); Nathaniel C. WYNN, Anaheim, CA (US); Angel Ruben RIVERA, Watertown, MA (US); Derek PAXSON, Boston, MA (US); Malcolm CUMMINGS, Somerville, MA (US); Alan SLEDD, Berkeley, CA (US); Marc Louis SYVERTSEN, Madison, WI (US); Mei ZHANG, Somerville, MA (US)

(21) Appl. No.: 19/061,979

(22) Filed: Feb. 24, 2025

Related U.S. Application Data
(60) Provisional application No. 63/556,749, filed on Feb. 22, 2024.

(51) Int. Cl. H01M 12/06; H01M 4/86; H01M 50/172; H01M 50/193; H01M 50/55; H01M 50/562

(52) U.S. Cl. CPC H01M 12/06; H01M 4/8605; H01M 50/172; H01M 50/193; H01M 50/55; H01M 50/562

(57) ABSTRACT

An electrochemical cell may include a vessel, a first module, a second module, and a gas diffusion electrode (GDE). The vessel has a thickness dimension. The first module includes a first anode sandwiched between two first oxygen evolution electrodes along the thickness dimension of the vessel. The second module includes a second anode sandwiched between two second oxygen evolution electrodes along the thickness dimension of the vessel. A gas diffusion electrode (GDE) is disposed between the first module and the second module in the vessel along the thickness dimension of the vessel.

### CROSS-REFERENCE TO RELATED APPLICATIONS

This application claims the benefit of priority to U.S. Provisional Application No. 63/556,749, filed Feb. 22, 2024, the entire contents of which are hereby incorporated herein by reference.

### BACKGROUND

Energy storage technologies are playing an increasingly important role in electric power grids. These energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for increased availability, reliability, and/or resiliency with reduced costs in energy storage systems.

### SUMMARY

According to an aspect, an electrochemical cell may include: a vessel having a thickness dimension; a first module including a first anode sandwiched between two first oxygen evolution electrodes along the thickness dimension of the vessel; a second module including a second anode sandwiched between two second oxygen evolution electrodes along the thickness dimension of the vessel; and a gas diffusion electrode (GDE) disposed between the first module and the second module in the vessel along the thickness dimension of the vessel.

In some implementations, the vessel may include a core, a first panel, and a second panel collectively encapsulating the first module, the second module, and the GDE. For example, the first panel and the second panel may be each welded to the core. Further, or instead, the first module, the second module, and the GDE may each be supported in place by the core of the vessel alone. Still further, or instead, all fluid ports into the vessel and all electrical connections into the vessel may pass through the core of the vessel.

In certain implementations, the first anode and the second anode may be load-bearing members within the vessel.

In some implementations, in the first module, the each of the two first oxygen evolution electrodes may be heat staked to the first anode and, in the second module, each of the two second oxygen evolution electrodes is heat staked to the second anode.

In certain implementations, the electrochemical cell may further include a first terminal extending through the vessel and into parallel electrical communication with the first anode and the second anode in the vessel. Further, or instead, the electrochemical cell may further include a second terminal extending through the vessel and into parallel electrical communication with the two first oxygen evolution electrodes and the two second oxygen evolution electrodes. Still further, or instead, the electrochemical cell may include a third terminal extending through the vessel and into electrical communication with the GDE. As an example, a polyamide seal may be overmolded on at least one of the first terminal, the second terminal, or the third terminal.

According to another aspect, a vessel for an electrochemical cell may include: a terminal electrically connectable to an external circuit; a seal overmolded on the terminal, the seal formed of a first polymer, the first polymer being a polyamide; and a core defining a ring, the core formed of a second polymer different from the first polymer, and the seal molded into the core with the terminal extending through the core into the ring such that the terminal is connectable in electrical communication with one or more electrodes supportable in the ring.

In some implementations, the terminal may be a nickel-plated.

In certain implementations, the polyamide of the first polymer may be nylon.

In some implementations, the second polymer of the core may be one or more of acrylonitrile butadiene styrene (ABS), high-density polyethylene (HDPE), polypropylene, or a low-molecular weight polyamide.

According to yet another aspect, a method of assembling an electrochemical cell may include securing a gas diffusion electrode (GDE) to a core in a position with the GDE within a ring collectively formed by sides of the core; securing at least one oxygen evolution electrode (OEE) and at least one anode relative to the GDE secured to the core; and sealing a first panel and a second panel to the core such that the first panel, the second panel, and the core enclose the GDE, the at least one OEE, and the at least one anode.

In certain implementations, securing the GDE to the core may include passing one or more electrical connections through the core from the GDE. For example, securing the at least one oxygen evolution electrode (OEE) and the at least one anode relative to the GDE secured to the core may include passing one or more electrical connections through the core from the at least one OEE and from the at least one anode. Further, or instead, the core may include one or more terminals and passing the one or more electrical connections through the core includes electrically connecting the at least one OEE, and the at least one anode to the one or more terminals.

In certain implementations, securing the at least one OEE and the at least one an anode relative to the GDE secured to the core may include securing an OEE on each side of the GDE secured to the core and securing an anode on each side of the GDE secured to the core.

In some implementations, securing the at least one OEE and the at least one anode relative to the GDE secured to the core may include connecting an electrode subassembly to the core, and the electrode subassembly includes the at least one OEE and the at least one anode mechanically coupled to one another.

In certain implementations, the first panel, the second panel, and the core may each be polymeric and sealing the first panel and the second panel to the core includes welding the first panel and the second panel to the core. For example, welding the first panel to the second panel to the core may include hot plate welding, infrared welding, ultraviolet welding, or laser welding. As an example, the first panel, the second panel, and the core are each acrylonitrile butadiene styrene (ABS). As another example, the first panel, the second panel, and the core may each be high density polyethylene (HDPE).

In some implementations, securing the GDE to the core may include flexing the core prior to sealing the first panel and the second panel to the core.

In certain implementations, securing the at least one OEE and the at least one anode relative to the GDE may include securing the at least one OEE and the at least one anode to the core. As an example, securing the at least one OEE and the at least one anode to the core may include flexing the core prior to sealing the first panel and the second panel to the core.

In some implementations, sealing the first panel and the second panel to the core may form tortuous fluid paths defined by the core, the first panel, and the second panel.

In certain implementations, the core may be injection molded.

In some implementations, the first panel and the second panel may each be thermoformed.

### DESCRIPTION OF THE DRAWINGS

FIG. 1 is a system block diagram of a power generation system according to various embodiments.

FIG. 2 is a system block diagram of a power generation system according to various embodiments.

FIG. 3 is a schematic representation of components of an electrochemical cell.

FIG. 4A is a perspective view of an outer portion of an electrochemical cell.

FIG. 4B is an exploded diagram of internal portions of the electrochemical cell of FIG. 4A.

FIG. 4C is a schematic representation of the arrangement of electrodes of the electrochemical cell shown in FIG. 4A.

FIG. 4D is a schematic representation of an arrangement of electrodes of an electrochemical cell, the arrangement of electrodes including a respective anode assembly between a respective oxygen evolution electrode (OEE) on either side of a gas diffusion electrode.

FIG. 5A is a schematic representation a module including a plurality of instances of electrochemical cells, with the schematic representation shown from an overhead view looking down the height (z dimension) of the plurality of instances of the electrochemical cells, and the plurality of electrochemical cells arranged in multiple rows from front to back of the module and with depth dimensions of each of the plurality of electrodes parallel with the side-to-side dimension of the module such that the plurality of electrochemical cells form a square footprint within the module.

FIG. 5B is a schematic representation of a module including a plurality of instances of electrochemical cells, with the schematic representation shown from an overhead view looking down the height (z dimension) of the plurality of instances of the electrochemical cells, and the plurality of electrochemical cells arranged in multiple rows from side-to-side of the module and with depth dimensions of each of the plurality of electrodes perpendicular to the side-to-side dimension of the module such that the plurality of electrochemical cells form a rectangular footprint within the module.

FIG. 5C is a schematic representation of a module including a plurality of instances of the electrochemical cells, with the schematic representation shown from an overhead view looking down the height (z dimension) of the plurality of instances of the electrochemical cells, the plurality of electrochemical cells arranged as a single row and with depth dimensions of the plurality of electrochemical cells perpendicular to the side-to-side dimension of the module such that the plurality of electrochemical cells form a rectangular footprint within the module.

FIG. 5D is a schematic representation of a module including a plurality of instances of the electrochemical cells, with the schematic representation shown from an overhead view looking down the height (z dimension) of the plurality of instances of the electrochemical cells, the plurality of electrochemical cells arranged as multiple rows from side-to-side with depth dimensions of each of the plurality of electrodes perpendicular to the side-to-side dimension of the module such that the plurality of electrochemical cells form a square footprint of the module.

FIG. 6A is a schematic representation of a top view of a sealed passthrough of a lid of the electrochemical cell of FIG. 4A.

FIG. 6B is a schematic representation of a cross-section of the sealed passthrough in the lid shown in FIG. 6A, with the cross-section taken along the line A-A in FIG. 6A.

FIG. 6C is a schematic representation of bellows sealing of the lid of the electrochemical cell of FIG. 4A.

FIG. 7A is a front view of a portion of an air electrode of the electrochemical cell of FIG. 4A.

FIG. 7B is a close-up, perspective view of a portion of the air electrode along the area of detail 7B in FIG. 7A.

FIGS. 8A-8B are a schematic representations of exemplary processes for pressing an air flow field in place during seal lamination of an electrode.

FIG. 9 is a schematic representation of an exemplary method for inserting a flow field into a pre-formed bifacial sealed electrode to form an electrode.

FIG. 10A is a schematic representation of a low pressure, high uniformity flow field using porous media for an electrode of an electrochemical cell.

FIG. 10B shows simulation results of a flow field along a long, narrow active area of an electrode, with the flow field formed using two symmetrical opposing strips of filter felt with a tapered geometry to balance pressure drop across the inlet to the outlet of the electrode.

FIG. 10C is a schematic representation of a flow field along a long, narrow active area of an electrode, with the flow field formed using a vertical feed and laterally positioned porous media strips to control and distribute air flow.

FIG. 10D shows simulation results of a flow field along a long, narrow active area of an electrode, with the flow field formed using horizontal serpentine channels of varying heights.

FIG. 10E shows simulation results of a flow field along a long, narrow active area of an electrode, with the flow field formed using vertical serpentine channels fed by a vertical inlet extending from a top of the flow field to a bottom of the flow field.

FIG. 10F is a schematic representation a long, narrow active area of an electrode including accordion folds of increasing height from top to bottom to form a flow field.

FIG. 10G is a schematic representation of a long, narrow active area of an electrode including a ladder structure of increasing spacing from top to bottom of the electrode.

FIG. 11A is a perspective view of the electrochemical cell of FIG. 4A, showing a top-down cross-section A-A along the electrochemical cell of FIG. 4A.

FIG. 11B is a top-down view of a cross-section of the electrochemical cell of FIG. 4A, with the cross-section taken along A-A in FIG. 11A.

FIG. 12 is a schematic representation of aspects of an electrode holder holding electrodes of an electrochemical cell.

FIG. 13A is a schematic representation of aspects of separating two electrodes with a mesh standoff.

FIG. 13B is a schematic representation of aspects of separating two electrodes with a corrugated standoff.

FIGS. 14A-C are schematic representations of aspects of anode assemblies.

FIGS. 15A-D are schematic representations of aspects of lid-to-vessel sealing.

FIG. 16 is a schematic representation of aspects of an anode operating as a primary structural member for an electrochemical cell.

FIG. 17 is a schematic representation of anodes used as vessels for electrochemical cells.

FIG. 18A is a perspective view of an electrochemical cell including a vessel formed of a core and panels.

FIG. 18B is a perspective view of the electrochemical cell of FIG. 18A with the panels removed.

FIG. 18C is a partially exploded, perspective view of the portion of the electrochemical cell shown in FIG. 18B.

FIG. 18D is a schematic side view of a configuration of oxygen evolution electrodes, anodes, and a gas diffusion electrode along a thickness dimension of the vessel of the electrochemical cell of FIG. 18A.

FIG. 19A is a close-up, front view of the area of detail 19A of the portion of the electrochemical cell shown in FIG. 18B.

FIG. 19B is a close-up, perspective view of the area of detail 19B in FIG. 19A.

FIG. 19C is a side, cross-sectional view of the portion of the electrochemical cell shown in FIG. 19B, the cross-section taken along 19C-19C in FIG. 19B.

FIG. 20 is a schematic representation of standoffs mounted on a separator, the standoffs angled for directing bubble egress.

Like reference symbols in the various drawings indicate like elements.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments is not intended to be limiting and, instead, is intended to enable a person skilled in the art to make and use these embodiments or combinations thereof.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the disclosure provided herein. Thus, the scope of the present disclosure should not be limited to a particular embodiment, configuration or arrangement that is set forth in a particular embodiment, example, or in an embodiment in a particular figure.

Embodiments of the present disclosure may include systems, methods, and devices for electrochemical energy storage systems, such as metal-air battery systems. Systems and methods of the various embodiments may provide for construction and configuration of electrodes and/or cell components of metal-air battery systems.

Various embodiments may provide devices and/or methods for use in long-duration, and ultra-long-duration, low-cost, energy storage, including in multi-day energy storage. Herein, “long duration” and “ultra-long duration” and similar such terms, unless expressly stated otherwise, should be given their broadest possible meaning and include periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and would include long duration energy storage (LODES) systems. Further, the terms “long duration” and “ultra-long duration”, “energy storage cells” including “electrochemical cells”, and similar such terms, unless expressly stated otherwise, should be given their broadest possible interpretation; and include electrochemical cells that may be configured to store energy over time spans of days, weeks, or seasons, such as electrochemical cells sometimes referred to as multi-day energy storage (MDS) cells. As a matter of definition, the term “duration” means the ratio of energy to power of an energy storage system. For example, a system with a rated energy of 24 MWh and a rated power of 8 MW has a duration of 3 hours; a system with a rated energy of 24 MWh and a rated power of 1 MW has a duration of 24 hours. Physically, this may be interpreted as the run-time at maximum power for the energy storage system.

In general, in an embodiment, the long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Various embodiments may provide devices and/or methods for use in bulk energy storage systems, such as long duration energy storage (LODES) systems (e.g., multi-day energy storage (MDS) systems), short duration energy storage (SDES) systems, etc. As an example, various embodiments may provide configurations and controls for batteries of bulk energy storage systems, such as batteries for LODES systems.

While various examples are discussed with reference to Li-ion and/or Fe-air, the discussion of Li-ion and/or Fe-air is used merely as an example and various embodiments encompass other combinations and permutations of storage technologies that may be substituted for the example solar+Li-ion+Fe-air discussions herein. For example, various metal-air storage technologies may be used as batteries in the various embodiments, such as Zinc-air, lithium-air, sodium-air, etc.

As used herein, the term “module” may refer to a string of unit electrochemical cells (e.g., a string of batteries). Multiple modules (or multiple units or electrochemical cells) may be connected together to form battery strings.

Unless otherwise expressed or made clear from the context, the recitation of any element in the singular shall be understood to be intended to encompass embodiments including one or more of such elements and the separate recitation of “one or more” is generally omitted for the sake of clarity and readability. Thus, for example, recitation of a LODES system 104 shall be understood to be inclusive of one or more LODES systems, etc.

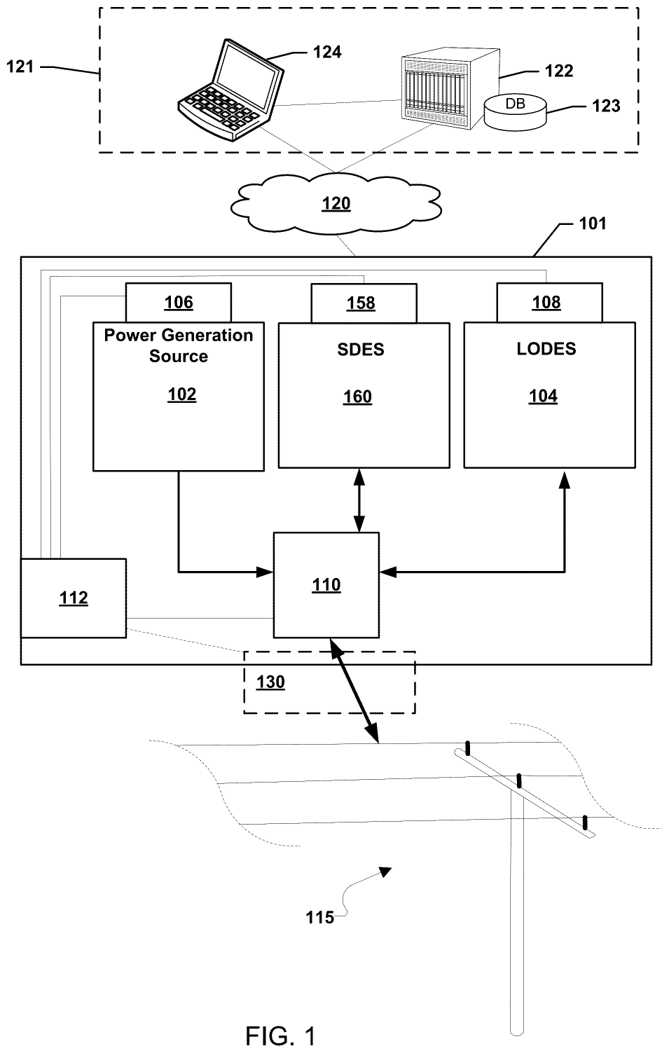

FIG. 1 is a system block diagram of a power generation system 101 according to various embodiments. The power generation system 101 may be a power plant including a power generation source 102, a LODES systems 104 (e.g., a multi-day energy storage (MDS) system), and an SDES systems 160. As examples, the power generation source 102 may include renewable power generation sources, non-renewable power generation sources, combinations of renewable and non-renewable power generation sources, etc. Examples of the power generation sources 102 include wind generators, solar generators, geothermal generators, nuclear generators, etc. The LODES system 104 may include an electrochemical cell (e.g., one or more batteries). The batteries of the LODES systems 104 may be any type of battery, such as rechargeable secondary batteries, refuellable primary batteries, combinations of primary and secondary batteries, etc. Battery chemistries may be any suitable chemistry, such as Al, AlCl₃, Fe, FeOₓ(OH)_{y}, NaₓS_{y}, SiOₓ(OH)_{y}, AlOₓ(OH)_{y}, metal-air, and/or any suitable type of battery chemistry. The SDES systems 160 may include one or more electrochemical cells (e.g., one or more batteries). The batteries of the SDES systems 160 may be any type of battery, such as rechargeable secondary batteries, refuellable primary batteries, combinations of primary and secondary batteries, etc. Battery chemistries may be any suitable chemistry, such as Li-ion, Na-ion, NiMH, Mg-ion, and/or any suitable type of battery chemistry.

In various embodiments, the operation of the power generation source 102 may be controlled by a first control system 106. The first control system 106 may include motors, pumps, fans, switches, relays, or any other type of devices that may control the generation of electricity by the power generation source 102. In various embodiments, the operation of the LODES system 104 may be controlled by a second control system 108. The second control system 108 may include motors, pumps, fans, switches, relays, or any other type of devices that may control the discharge and/or storage of electricity by the LODES system. In various embodiments, the operation of the SDES system 160 may be controlled by a third control system 158. The third control system 158 may include motors, pumps, fans, switches, relays, or any other type of devices that may control the discharge and/or storage of electricity by the SDES system 160. The first control system 106, the second control system 108, and the third control system 158 may each be connected to a plant controller 112. The plant controller 112 may monitor the overall operation of the power generation system 101 and generate and send control signals to the first control system 106, the second control system 108, and the third control system 158 to control the operations of the power generation source 102, the LODES system 104, and/or the SDES system 160.

In the power generation system 101, the power generation source 102, the LODES system 104, and the SDES system 160 may each be connected to a power control device 110. The power control device 110 may be connected to a power grid 115 or other transmission infrastructure. The power control device 110 may include switches, inverters (e.g., AC to DC inverters, DC to AC inverters, etc.), relays, power electronics, and any other type of devices that may control the flow of electricity from to/from the power generation source 102, the LODES system 104, the SDES system 160, and/or the power grid 115. Additionally, or alternatively, the power generation system 101 may include transmission facilities 130 connecting the power generation, transmission, and the power generation system 101 to the power grid 115. As an example, the transmission facilities 130 may connect between the power control device 110 and the power grid 115 such that electricity may flow between the power generation system 101 and the power grid 115. Transmission facilities 130 may include transmission lines, distribution lines, power cables, switches, relays, transformers, and any other type of devices that may support the flow of electricity between the power generation system 101 and the power grid 115. The power control device 110 and/or the transmission facilities 130 may be connected to the plant controller 112. The plant controller 112 may monitor and control the operations of the power control device 110 and/or the transmission facilities 130, such as via various control signals. As examples, the plant controller 112 may control the power control device 110 and/or the transmission facilities 130 to provide electricity from the power generation source 102 to the power grid 115, to provide electricity from the LODES system 104 to the power grid 115, to provide electricity from both the power generation source 102 and the LODES system 104 to the power grid 115, to provide electricity from the power generation source 102 to the LODES system 104, to provide electricity from the power grid 115 to the LODES system 104, to provide electricity from the SDES system 160 to the power grid 115, to provide electricity from both the power generation source 102 and the SDES system 160 to the power grid 115, to provide electricity from the power generation source 102 to the SDES system 160, to provide electricity from the power grid 115 to the SDES system 160, to provide electricity from the SDES system 160 and the LODES system 104 to the power grid 115, and/or to provide electricity from the power generation source 102, the SDES system 160, and the LODES system 104 to the power grid 115. In various embodiments, the power generation source 102 may selectively charge the LODES system 104 and/or SDES system 160 and the LODES system 104 and/or SDES system 160 may selectively discharge to the power grid 115. In this manner, energy (e.g., renewable energy, non-renewable energy, etc.) generated by the power generation source 102 may be output to the power grid 115 sometime after generation from the LODES system 104 and/or the SDES system 160.

In various embodiments, the plant controller 112 may be in communication with a network 120 (e.g., 3G network, 4G network, 5G network, core network, Internet, combinations of the same, etc.). Using the connections to the network 120, the plant controller 112 may exchange data with the network 120 as well as with devices connected to the network 120, such as a plant management system 121 or any other device connected to the network 120. The plant management system 121 may include one or more computing devices, such as a computing device 124 and a server 122. The computing device 124 and the server 122 may be connected to one another directly and/or via connections to the network 120. The various connections to the network 120 by the plant controller 112 and devices of the plant management system 121 may be wired and/or wireless connections.

In various embodiments, the computing device 124 of the plant management system 121 may provide a user interface that facilitates providing user-defined inputs to the plant management system 121 and/or to the power generation system 101, receiving indications associated with the plant management system 121 and/or with the power generation system 101, and/or otherwise controlling operation of the plant management system 121 and/or the power generation system 101.

While shown as two separate devices, 124 and 122, the functionality of the computing device 124 and server 122 described herein may be combined into a single computing device or may split among more than two devices. Additionally, or alternatively, while shown as part of the plant management system 121, the functionality of one or both the computing device 124 and the server 122 may be entirely, or partially, carried out by a remote computing device, such as a cloud-based computing system. Further, or instead, while shown as being in communication with a single instance of the power generation system 101, the plant management system 121 may be in communication with multiple instances of the power generation system 101.

While shown as being located together in FIG. 1, the power generation source 102, the LODES system 104, and the SDES system 160 may be physically separated from one another in various implementations. For example, the LODES system 104 may be downstream of a transmission constraint, such as downstream of a portion of the power grid 115, downstream from the power generation source 102 and SDES system 160, etc. In this manner, the overbuild of underutilized transmission infrastructure may be reduced, or even avoided, by situating the LODES system 104 downstream of a transmission constraint, charging the LODES system 104 at times of available capacity and discharging the LODES system 104 at times of transmission shortage. The LODES system 104 may also, or instead, arbitrate electricity according to prevailing market prices to reduce the final cost of electricity to consumers.

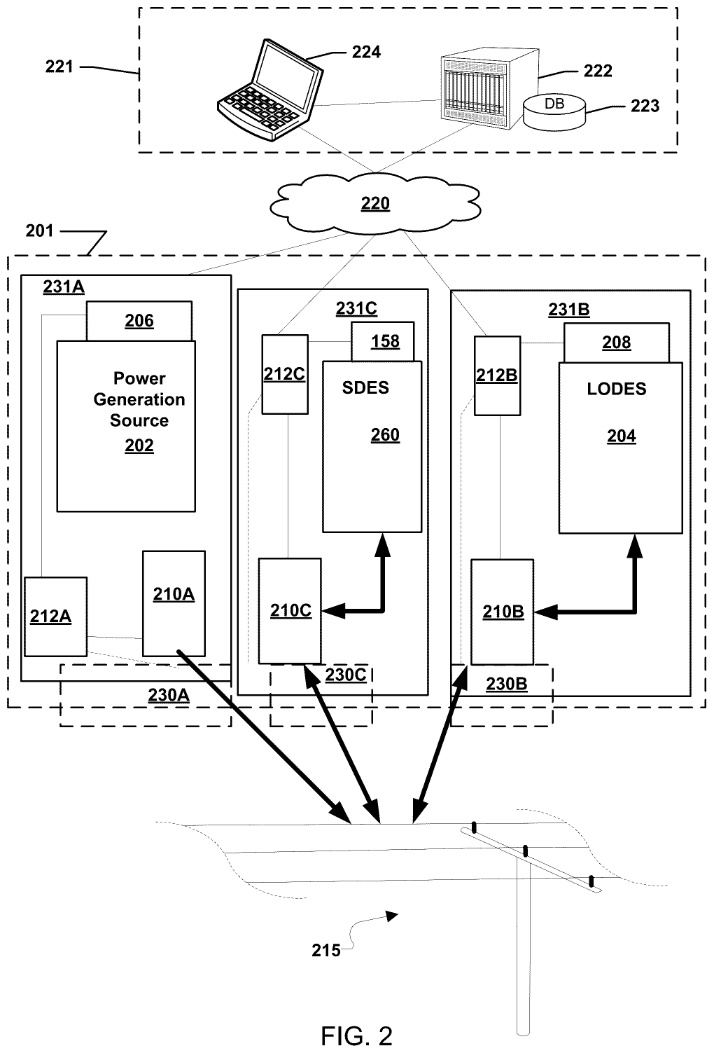

FIG. 2 is a system block diagram of a power generation system 201 in which various elements of the power generation system 201 may be physically separated from one another according to various embodiments. For the sake of clear and efficient description, elements in FIG. 2 with numbers having the same last two digits as in FIG. 1 shall be understood to be analogous to or interchangeable with one another, unless otherwise specified or made clear from the context, and, therefore, are not described separately from one another, except to note differences and/or to emphasize certain features. For example, the power generation system 101 (FIG. 1) shall be understood to be analogous to and/or interchangeable with the power generation system 201, unless a contrary intent is expressed or made clear from the context.

As an example, the power generation system 201 may include a power generation source 202 and one or more bulk energy storage systems, such as a LODES system 204 and/or an SDES system 260. The power generation source 202, the LODES system 204, and/or the SDES system 160 may be separated in the power plants 231A, 231B, 231C, respectively. While the power plants 231A, 231B, 231C may be separated from one another, the power generation system 201 and a plant management system 121 may operate as described above with reference to operation of the power generation system 101 and the plant management system 121 (FIG. 1). While the power plants 231A, 231B, and 231C may be co-located or may be geographically separated from one another. The power plants 231A, 231B, and 231C may connect to the power grid 215 at different places. For example, the power plant 231A may be connected to the power grid 215 upstream of where the power plant 231B is connected.

In some implementations, the power plant 231A associated with the power generation source 202 may include dedicated equipment for the control of the power plant 231A and/or for transition of electricity to/from the power plant 231A. For example, the power plant 231A may include a plant controller 212A and a power controller 110A and/or a transmission facility 230A. The power controller 210A and/or the transmission facility 230 may be connected in electrical communication with the plant controller 112A. The plant controller 212A may, for example, monitor and control the operations of the power controller 210A and/or the transmission facility 230A, such as via various control signals. As examples, the plant controller 212A may control the power controller 210A and/or transmission facility 230A to provide electricity from the power generation sources 202 to the power grid 215, etc.

Additionally, or alternatively, the power plant 231B associated with the LODES system 204 may include dedicated equipment for the control of the power plant 231B and/or for transmission of electricity to/from the power plant 231B. For example, the power plant 231B associated with the LODES system 204 may include a plant controller 112B, a power controller 210B, and/or a transmission facility 230B. The power controller 210B and/or the transmission facility 230B may be connected to the plant controller 212B. The plant controller 212B may monitor and control the operations of the power controller 210B and/or of the transmission facility 230B, such as via various control signals. As an example, the plant controller 212B may control the power controller 210B and/or the transmission facility 230B to provide electricity from the LODES system 204 to the power grid 215 and/or to provide electricity from the power grid 215 to the LODES system 204, etc.

Still further, or instead, the power plant 231C associated with the SDES system 260 may include dedicated equipment for the control of the power plant 231C and/or for transmission of electricity to/from the power plant 231C. For example, the power plant 231C associated with the SDES system 260 may include a plant controller 212C and a power controller 210C and/or a transmission facility 230C. The power controller 210C and/or the transmission facility 230C may be connected to the plant controller 212C. The plant controller 212C may monitor and control the operations of the power controller 210C and/or transmission facility 230C, such as via various control signals. As examples, the plant controller 212C may monitor and control the operations of the power controller 210C and/or transmission facility 230C, such as via various control signals. As examples, the plant controller 212 may control the power controller 210C and/or the transmission facility 230C to provide electricity from the SDES system 260 to the power grid 215 and/or to provide electricity from the power grid 215 to the SDES system 260, etc.

In various embodiments, the plant controllers 212A, 212B, 212C may each be in communication with each other and/or with a network 220. Using the connections to the network 220, the plant controllers 212A, 212B, 212C may exchange data with the network 220 as well as with one or more devices connected to the network 220, such as a plant management system 221, each other, or any other device connected to the network 220. In various embodiments, the operation of the plant controllers 212A, 212B, 212C may be monitored by the plant management system 221 and the operation of the plant controllers 212A, 212B, 212C—and, thus, operation of the power generation system 201, may be controlled by the plant management system 221.

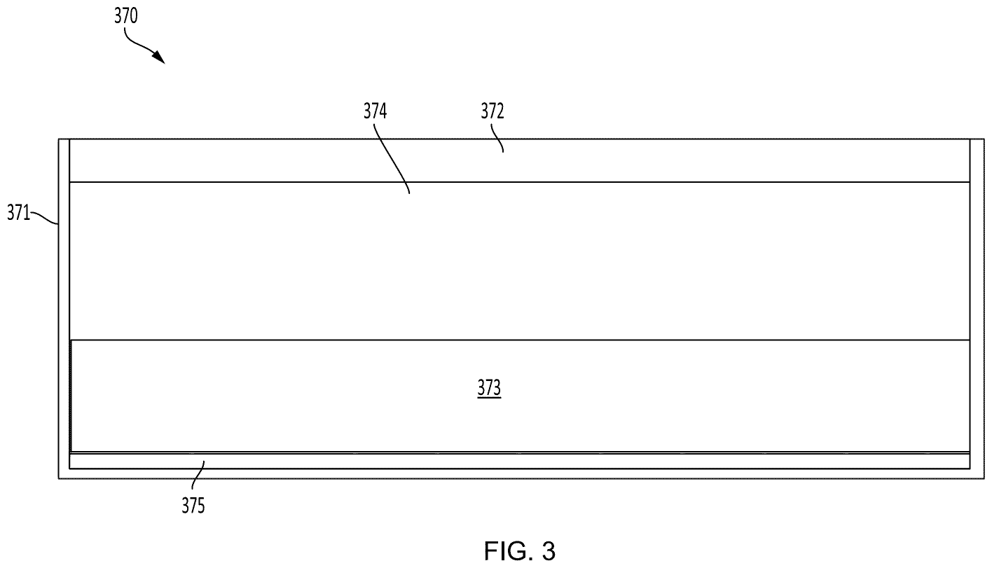

FIG. 3 is a schematic view of a battery 370 that may be used in the one or more LODES systems described herein (e.g., the LODES system 204 in FIG. 1 and/or the LODES system 204 in FIG. 2). The battery 370 may include a vessel 371, a gas diffusion electrode (GDE) 372, an anode 373, an electrolyte 374, and a current collector 375. The GDE 372, the anode 373, the electrolyte 374, and the current collector 375 may each be disposed in the vessel 371. The anode 373 may include a metal electrode (e.g., an iron electrode, a lithium electrode, a zinc electrode, or other type of suitable metal). The electrolyte 374 may separate the GDE 372 from the anode 373. Additionally, specific examples of batteries, such as batteries similar to battery 370, that may be used in bulk energy storage systems, such as in LODES systems of the present disclosure are described in U.S. Pat. App. Pub. 2021/0028457, the entire contents of which are incorporated herein by reference. As examples, the battery 370 may be a metal-air type battery, such as an iron-air battery, a lithium-air battery, a zinc-air battery, etc. While various examples are discussed with reference to metal-air batteries, other type batteries may be additionally, or alternatively, used in the various examples provided herein unless otherwise specified or made clear from the context. The battery 370 may be a single cell or unit, and multiple instances of the battery 370—namely, multiple units or cells—may be connected together to form a module. Multiple modules may be connected to one another to form a battery string.

In various embodiments, the anode 373 may be solid and the electrolyte may be excluded from the anode. In various embodiments the anode 373 may be porous and the electrolyte 374 may be interspersed geometrically with the anode 373, creating a greater interfacial surface area for reaction. Further, or instead, the air electrode 203 may be porous and the electrolyte 374 may be interspersed geometrically with the anode 373, creating a greater interfacial surface area for reaction. Still further, or instead, the GDE 372 may be at an interface of the electrolyte 374 and a gaseous headspace (not shown in FIG. 3). The gaseous headspace may, for example, be sealed in a housing. Additionally, or alternatively, the housing may be unsealed and the gaseous headspace may be an open system which can freely exchange mass with the environment.

The anode 373 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the forgoing metallic elements, such as an aluminum alloy or iron alloy (e.g., FeAl, FeZn, FeMg, etc.) that can undergo an oxidation reaction for discharge. As such, the anode 373 may be referred to as a metal electrode herein.

In certain embodiments, the battery 370 may be rechargeable and the anode 373 may undergo a reduction reaction when the battery 370 is charged. The anode 373 may be a solid, including a dense or porous solid, or a mesh or foam, or a particle or collection of particles, or may be a slurry, ink, suspension, or paste deposited within the housing. In various embodiments, composition of the anode 373 may be selected such that the anode 373 and the electrolyte 374 do not mix together to any substantial extent, allowing for only small amounts of solubility that do not impact performance of the battery 370. For example, the anode 373 may be a metal electrode that may be a bulk solid. Further, or instead, the anode 373 may include a collection of particles, such as small or bulky particles, within a suspension, and the collection of particles may not be buoyant enough to escape the suspension into the electrolyte 374. Additionally, or alternatively, the anode 373 may include particles that are not buoyant in the electrolyte 374.

The GDE 372 may support the reaction with oxygen. As an example, the GDE 372 may be a solid and may sit at the interface of a gas headspace and the electrolyte 374. During the discharge process, the GDE 372 may support the reduction of oxygen from the gaseous headspace, in a reaction known as the Oxygen Reduction Reaction (ORR). In certain embodiments, the battery 370 may be rechargeable and the reverse reaction may occur—namely, the reaction in which the GDE supports the evolution of oxygen from the battery, in a reaction known as Oxygen Evolution Reaction (OER). The OER and ORR reactions are commonly known to those skilled in the art.

In various embodiments, the electrolyte 374 may be a liquid electrolyte. For example, the electrolyte 374 may be an aqueous solution, a non-aqueous solution, or a combination thereof. In various embodiments, the electrolyte 374 may be an aqueous solution which may be acidic (low-pH), neutral (intermediate pH), or basic (high pH; also called alkaline or caustic). In certain embodiments, the electrolyte 374 may comprise an electropositive element, such as Li, K, Na, or combinations thereof. In some embodiments, the liquid electrolyte may be basic, namely with a pH greater than 7. In some embodiments the pH of the electrolyte may be greater than 10 (e.g., greater than 12). For example, the electrolyte 374 may include a 6M (mol/liter) concentration of potassium hydroxide (KOH). In certain embodiments, the electrolyte 374 may include a combination of ingredients such as 5.5M potassium hydroxide (KOH) and 0.5M lithium hydroxide (LiOH). In certain embodiments, the electrolyte 374 may comprise a 6M (mol/liter) concentration of sodium hydroxide (NaOH). In certain embodiments, the electrolyte 374 may comprise a 5M (mol/liter) concentration of sodium hydroxide (NaOH) and 1M potassium hydroxide (KOH).

In certain embodiments, the battery 370 (e.g., metal-air battery) may discharge by reducing oxygen (O₂) typically sourced from air. This may achieved by a triple-phase contact between gaseous oxygen, an electronically active conductor which supplies the electrons for the reduction reaction, and the electrolyte 374 which contains the product of the reduction step. For example, in certain embodiments involving an aqueous alkaline electrolyte, oxygen from air may be reduced to form hydroxide ions through the half-reaction O₂+2H₂O+4e⁻→4OH⁻. Thus, oxygen delivery to metal-air cells may include gas handling and maintenance of triple-phase points. In certain embodiments, sometimes referred to as “normal air-breathing” configurations, the GDE 372 may be positioned at the gas-liquid interface to promote and maintain triple-phase boundaries. The GDE 372 may be positioned vertically or horizontally, or at any intermediate angle with respect to gravity, and maintain a “normal air-breathing” configuration. In these “normal air-breathing” configurations, the gas phase is at atmospheric pressure—that is, gas phase is unpressurized beyond the action of gravity.

The battery 370 in FIG. 3 is merely an example of one electrochemical cell according to various embodiments and is not intended to be limiting. Other configurations, such as electrochemical cells with different types of vessels and/or without the vessel 371, electrochemical cells with different types of air electrodes and/or without the GDE 372, electrochemical cells with different types of current collectors and/or without the current collector 375, electrochemical cells with different types of anodes and/or without the anode 373, and/or electrochemical cells with different types of electrolytes and/or electrochemical cells without the electrolyte 374 may be substituted for the example configuration of the battery 370, and other arrangements are in accordance with the various embodiments.

In various embodiments, the vessel 371 may be made from a polymer such as polyethylene, acrylonitrile butadiene styrene (ABS), high-density polyethylene (HDPE), ultra-high molecular weight polyethylene (UHMW), polypropylene, and/or other polymers. In certain embodiments, the vessel 371 and/or housing for the battery 370 may be made from a metal such as nickel, steel, anodized aluminum, nickel coated steel, nickel coated aluminum or other metal.

In various embodiments, a battery (e.g., the battery 370) may include three electrodes—an anode (e.g., the anode 373) and a dual cathode (e.g., GDE 372 including two parts, such as a first cathode, and a second cathode). The electrodes may have finite useful lifetimes, and may be mechanically replaceable. For example, the anode may be replaced seasonally. The first cathode of the dual cathode may be divided into two portions, a first portion having a hydrophilic surface and a second portion having a hydrophobic surface. For example, the hydrophobic surface may have a polytetrafluorethylene (PTFE) (e.g., Teflon®) hydrophobic surface.

For example, the second portion having the hydrophobic surface may include a microporous layer of polytetrafluorethylene (PTFE) and high surface area carbon while the first portion having the hydrophilic surface may include carbon fiber partially coated with PTFE. As another example, the second portion may include a microporous layer of PTFE and carbon black and the first portion may include PTFE of approximately 33% by weight. As a further example, the second portion may include a microporous layer of 23% by weight PTFE and 77% by weight carbon black and the first portion may include a low loading microporous layer. The anode may be an iron (Fe) electrode or an iron-alloy (Fe-alloy) electrode (e.g., FeAl, FeZn, FeMg, etc.). The second cathode of the dual cathode may include a hydrophilic surface. The second cathode of the dual cathode may include a metal substrate, such as carbon (C), titanium (Ti), steel, etc., coated with nickel (Ni). Electrolyte (e.g., electrolyte 140) may be disposed between the three electrodes. The electrolyte may be infiltrated into one or more of the three electrodes.

Battery systems may include a number of cells connected in series and/or parallel in a shared electrolyte bath and contained in a housing.

Referring now to FIGS. 1-4C, FIG. 4A an electrochemical cell 400 may include at least one battery, such as at least one instance of the battery 200, in accordance with various embodiments. In some implementations, the electrochemical cell 400 may include a vessel 401 (e.g., such as the vessel 371), in which an air electrode (e.g., a cathode), such as the GDE 372, a negative electrode (e.g., an anode), such as the anode 373, and an electrolyte, such as the electrolyte 374, are disposed. The electrolyte, such as the electrolyte 374, may rise to a given level within the vessel 401 and a headspace between the top of the vessel 401 and electrolyte level may be formed in the electrochemical cell 400. The vessel 401 may have a height (e.g., a z dimension), a width (e.g., a y dimension), and a depth (e.g., a x dimension). In one example configuration, the height may be greater than the width and depth and the width may be greater than the depth such that the vessel 401 is a generally rectangular cuboid. The vessel 401 may include one or more various connections, such as electrical connections, electrolyte connections, gas connections (e.g., air connections), vents, etc. Via the connections, two or more electrochemical cells (e.g., two or more instances of the electrochemical cell 400) may be connected together, such as in series and/or in parallel, to form a module.

In a module formed of a plurality of instances of the electrochemical cell 400, each instance of the electrochemical cell 400 may be a self-contained unit supporting its own respective air electrode (e.g., the GDE 372), anode electrode (e.g., the anode 373), and electrolyte (e.g., the electrolyte 374). The module structure may support the vessel 401 of the electrochemical cells 400 disposed within the given module.

The vessel 401 may have disposed within it one or more instances of an anode assembly 402a,b (e.g., one or more instances of the anode 373), one or more instances of a cathode (e.g., the air electrode 203), and an electrolyte (e.g., the electrolyte 374). As an example, each instance of the cathode assembly may include a respective instance of an Oxygen Evolution Electrode (OEE) 403a,b and a gas diffusion electrode (GDE) 404. A battery including at least one instance of the OEE 403 and at least one instance of the GDE 404 may be referred to as a multi-cathode battery cell.

A first OEE 403a may be disposed within the vessel 401, between a first anode assembly 402a and the GDE 404. On the opposite side of the GDE 404, a second OEE 403b and a second anode assembly 402b may be in a mirror configuration relative to the GDE 404. That is, within the vessel 401, the GDE 404 may be disposed between symmetric arrangements of: 1) the first anode assembly 402a and the first OEE 403a; and 2) the second anode assembly 402b and the second OEE 403b. As a specific example, the GDE 404 may be disposed centrally within a volume defined by the vessel 401, such that the length and width of the GDE 404 is at least partially disposed along a center plane defined by the length and width of the volume defined by the vessel 401 and intersecting a midpoint of the depth dimension of the volume defined by the vessel 401. Air may enter the volume of the vessel 401 and pass into the GDE 404 (e.g., into a center portion of the GDE 404) between the first OEE 403a and the second OEE 403b. The electrochemical cell 400 may include first standoff elements 451 between the first anode assembly 402a and the first OEE 403a and between the second anode assembly 402b and the second OEE 403b. Further, or instead, the electrochemical cell 400 may include second standoff elements 452 between the first OEE 403a and the GDE 404 and between the second OEE 403b and the GDE 404. However, such internal arrangement of the electrochemical cell 400 is merely one example configuration within the vessel 401, and is not intended to be limiting.

In some implementations, the electrochemical cell 400 may include an electronics structure 450, which may include a printed circuit board assembly (PCBA), circuitry housing, etc., as may be useful for supporting various electronic devices (e.g., controllers, sensors, switches, wiring buses, etc.) that may control and/or manage one or more operations of the electrochemical cell 400. The electrochemical cell 400 may additionally, or alternatively, include a lid 455 and an electrode holder 454 on opposite sides along a length dimension of the vessel 401. Straps 453 may secure the lid 455 and the electrode holder 454 to the vessel 401. The electronics structure 450 may be supported on the lid 455 in some configurations.

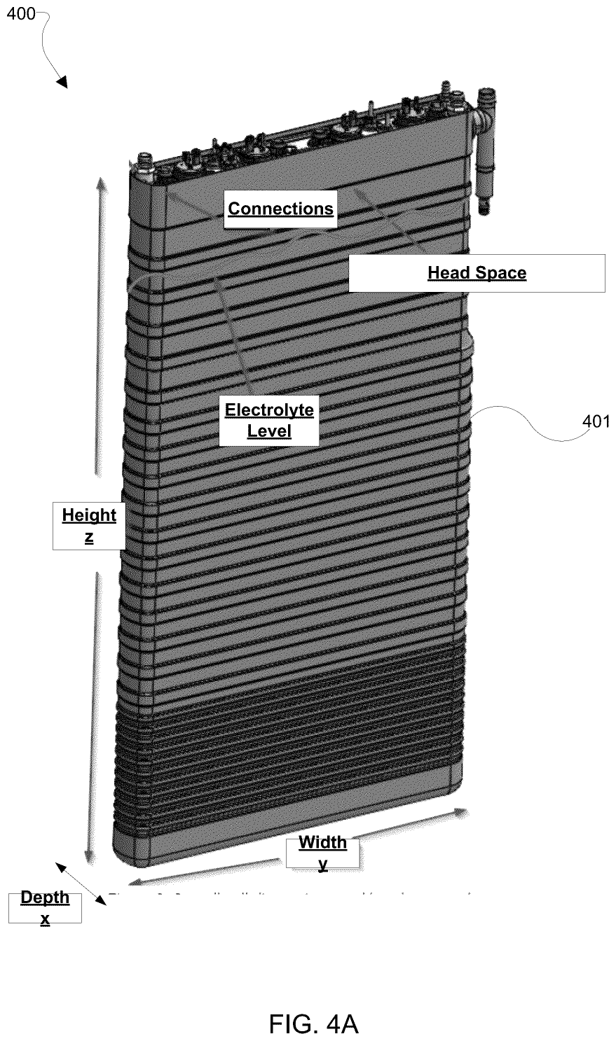

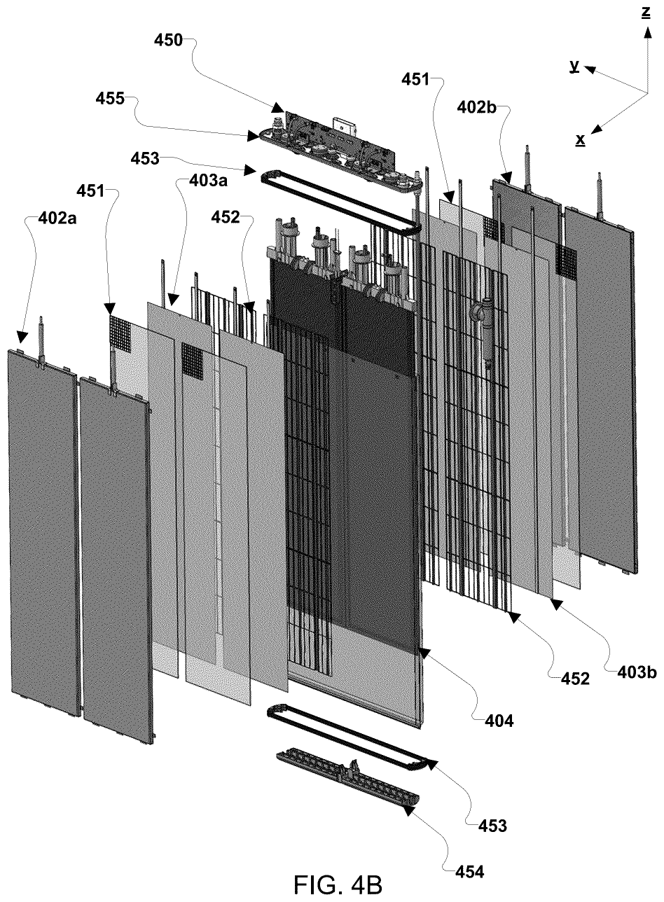

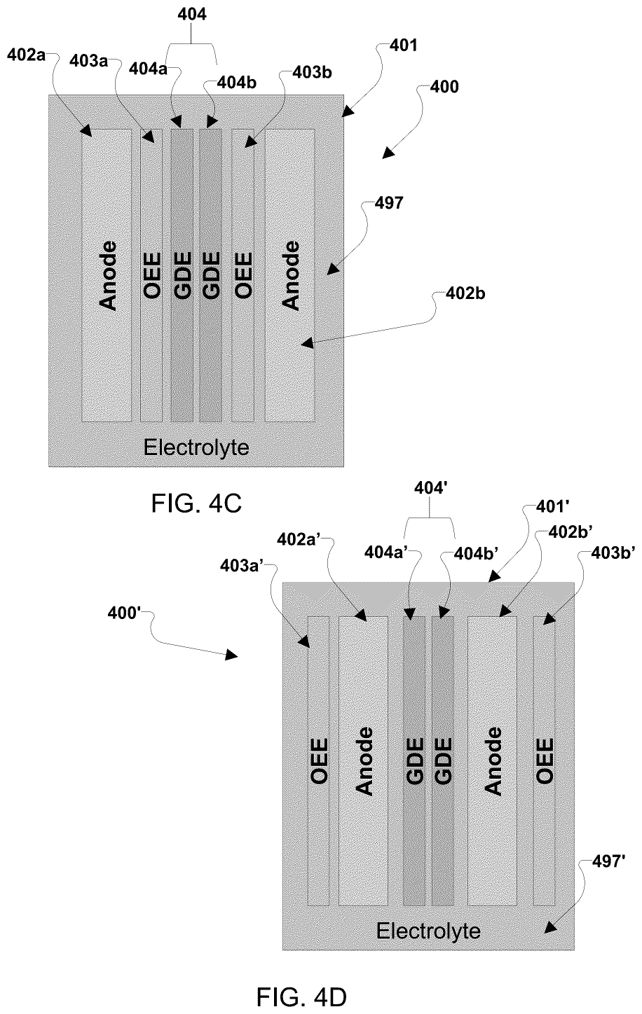

In general, the first OEE 403a, the first anode assembly 402a, the GDE 404, the second OEE 403b, and the second anode assembly 402b may each be disposed in an electrolyte 497 within the volume of the vessel 401 of the electrochemical cell 400. As discussed herein, the GDE 404 may include a two part electrode with two faces sealed on three-sides to form a two-faced pocket construction defining a central air passage between the two faces. As compared to other configurations, the amount of inactive material used in construction of the GDE 404 (e.g. flowfield, epoxy “trough” or frame) may be reduced by making a 2-sided GDE (air in the middle with active faces on either side). To facilitate construction of the GDE 404, the first anode assembly 402a and the first OEE 403a may be mirrored about the GDE 404 by the second anode assembly 402b and the second OEE 403b. Along the depth dimension of the vessel 401, in a direction from right to left in FIG. 4C, a construction of electrodes within the vessel 401 of the electrochemical cell 400 may be: the first anode assembly 402a|the first OEE 403a|a first portion 404a of the GDE 404|a second portion 404b of the GDE 404|the second OEE 403b|the second anode assembly 402b. For ease of manufacturing and assembly, each electrode may be further divided into two mechanically distinct electrodes across the width dimension of the vessel 401—thus resulting in the electrochemical cell having 4 anodes (e.g., two instances of the first anode assembly 402a and two instances of the second assembly 402b), 4 OEEs (e.g., two instances of the first OEE 403a and two instances of the second OEE 403b), and two instances of the GDE 404. Electrically and electrochemically, all electrodes may function as a parallel circuit (e.g. common potential among all anodes).

With reference to FIGS. 1-4C and 5A, a module 501 is shown from an overhead view looking down the height (e.g., z dimension) of a plurality of instances of the electrochemical cell 400. The module 501 may be a generally square configuration with the front, back, and sides of the module 501 about the same lengths. In the module 501, the plurality of instances of the electrochemical cell 400 may be arranged in two rows such that the respective width dimensions of the plurality of instances of the electrochemical cell are parallel to the sides of the module 501 and the respective depths of the vessel 401 run parallel to the front and back of the module 501. In the configuration of the module 501, the combined width of the two rows of the plurality of instances of the electrochemical cell 400, along with any spacing between the two rows and the front and the back of the module, may generally govern the length of each side of the module 501. The number of instances of the electrochemical cell 400 in each row and the depth dimension of each instance of the vessel 401, along with the spacing between the instances of the vessel 401 in each row and the spacing of the respective rows from the sides of the module 501, may generally govern the length from the front to the back of the module 501. As described in greater detail below, other arrangements of a plurality of instances of the electrochemical cells 400 are additionally, or alternatively, possible to form modules with other footprints.

While various aspects of electrochemical cells and modules of such electrochemical cells have been described, it shall be appreciated that other implementations are additionally or alternatively possible.

For example, while the electrochemical cell 400 has been described as including one type of mirrored arrangement of anode assemblies and OEEs relative to the GDE 404, it shall be appreciated that another type of mirrored arrangement is additionally or alternatively possible. For example, referring now to FIG. 4D, along a depth dimension of a vessel 401′ in a direction from left to right in FIG. 4D, a construction of electrodes within the vessel 401′ of an electrochemical cell 400′ may be: a first OEE 403a′|a first anode assembly 402a′|the first portion 404a′ of the GDE 404′|the second portion 404b of the GDE 404′|a second anode assembly 402b|and a second OEE 403b′. In this context, element numbers designated with a prime (′) shall be understood to be identical to corresponding element numbers that are unprimed, except to the extent necessary to accommodate the different positioning of electrodes in FIG. 4D relative to the positioning shown in FIGS. 4B and 4C. Further, or instead, the electrochemical cell 400′ shall be understood to be interchangeable with the electrochemical cell 400 in the description that follows. However, for the sake of clear and efficient description, the description, reference in the description that follows is made only to the electrochemical cell 400.

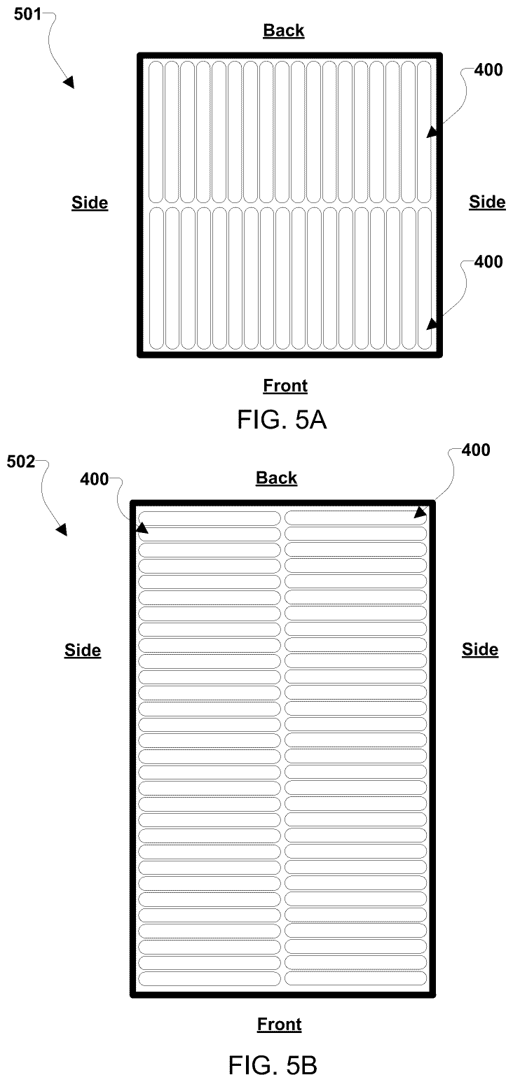

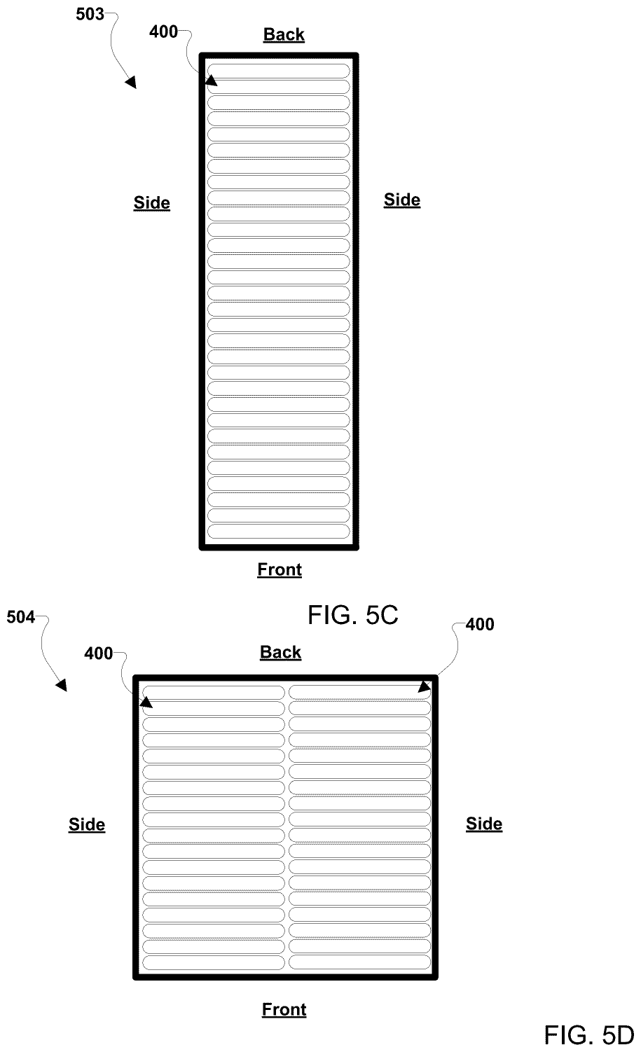

As another example, while the module 501 has been described as having a particular arrangement of electrochemical cells to form a particular footprint, it shall be appreciated that other arrangements of electrochemical cells are additionally or alternatively possible to form modules. As an example, referring now to FIG. 5B, a module 502 configuration may include multiple instances of the electrochemical cell 400 in accordance with various embodiments. The module 502 configuration may be a generally rectangular configuration with the sides of the module 502 longer than the back and front of the module 502. In the module 502, two rows of instances of the electrochemical cell 400 may be arranged such that the widths of the plurality of instances of the electrochemical cell 400 are parallel to the front and back of the module 502 and the depths of the plurality of instances of the electrochemical cell 400 are parallel to the sides of the module 502. In the configuration of the module 502, the widths of two instances of the electrochemical cell 400 may generally govern the length of the front and back of the module 502 along with any spacing between the rows of instances of the electrochemical cell 400 and spacing of the respective rows and the sides of the module 502. The number of instances of the electrochemical cell 400 in each row and the depth of the plurality of instances of the electrochemical cells 400 may generally govern the length of the sides of the module 502 along with the spacing between the plurality of instances of the electrochemical cells 400 in each row and the spacing of the respective rows and the front and back of the module 502.

As another example, referring now to FIG. 5C, a module 503 configuration may include multiple instances of the electrochemical cell 400 in accordance with various embodiments. The module 503 may be a generally rectangular configuration with the sides of the module 503 longer than the back and front of the module 503. In the module 503, a single row of instances of the electrochemical cell 400 may be arranged such that the widths of the instances of the electrochemical cell 400 are parallel to the front and back of the module 503 and the depths of the instances of the electrochemical cell 400 are parallel to the sides of the module 502. In the module 503, the widths of the single row of instances of the electrochemical cell 400 may generally govern the length of the front and back of the module 503 along with any spacing between the sides of the module 503. The number instances of the electrochemical cell 400 in the row and the depth of the instances of the electrochemical cell 400 may generally govern the length of the sides of the module 503 along with the spacing between the instances of the electrochemical cell 400 in the row and the spacing between the front and back of the module 503.

As yet another example, referring now to FIG. 5D a module 504 may be generally square with the front, back, and sides of the module 504 about the same lengths. In the module 504, two rows of instances of the electrochemical cell 400 may be arranged such that the widths of the instances of the electrochemical cell 400 are parallel to the front and back of the module 504 and the depths of the instances of the electrochemical cell 400 are parallel to the sides of the module 504. In the module 504, the widths of the two instances of the electrochemical cell 400 may generally govern the length of the front and back of the module 504 along with any spacing between the rows of instances of the electrochemical cell 400 and spacing of the respective rows and the sides of the module 504. The number of instances of the electrochemical cell 400 in each row and the depths of the instances of the electrochemical cell 400 may generally govern the length of the sides of the module 504 along with the spacing between the instances of the electrochemical cell 400 in each row and the spacing of the respective rows and the front and back of the module 504.

Other configurations, of a plurality of instances of the electrochemical cell are additionally or alternatively possible, such as modules with more or fewer rows, modules with non-linear arrangements of electrochemical cells, modules with more or fewer electrochemical cells, etc., may be substituted for the example configuration of the modules described above and other configurations are in accordance with the various embodiments.

In various embodiments, battery modules having strings of electrochemical cells therein may be enclosed in an enclosure. The enclosure may house one or more instances of a module, with each instance of a module having strings of electrochemical cells therein. In description that follows, enclosures are described with respect to a plurality of instances of the module 501 (FIG. 5A). It shall be appreciated, however, that this is for the sake of clear and efficient description. That is, unless otherwise indicated or made clear from the context, any reference the module 501 (FIG. 5A) in enclosures shall be understood to apply equally to any other arrangement of electrochemical cells in a module and, thus, shall be understood to apply equally to the module 502 (FIG. 5B), to the module 503 (FIG. 5C), and to the module 504 (FIG. 5D).

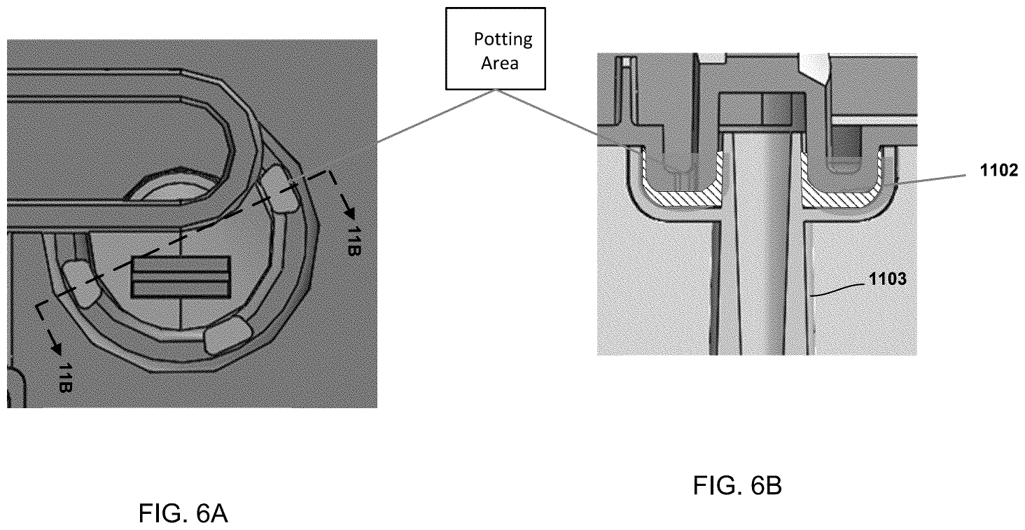

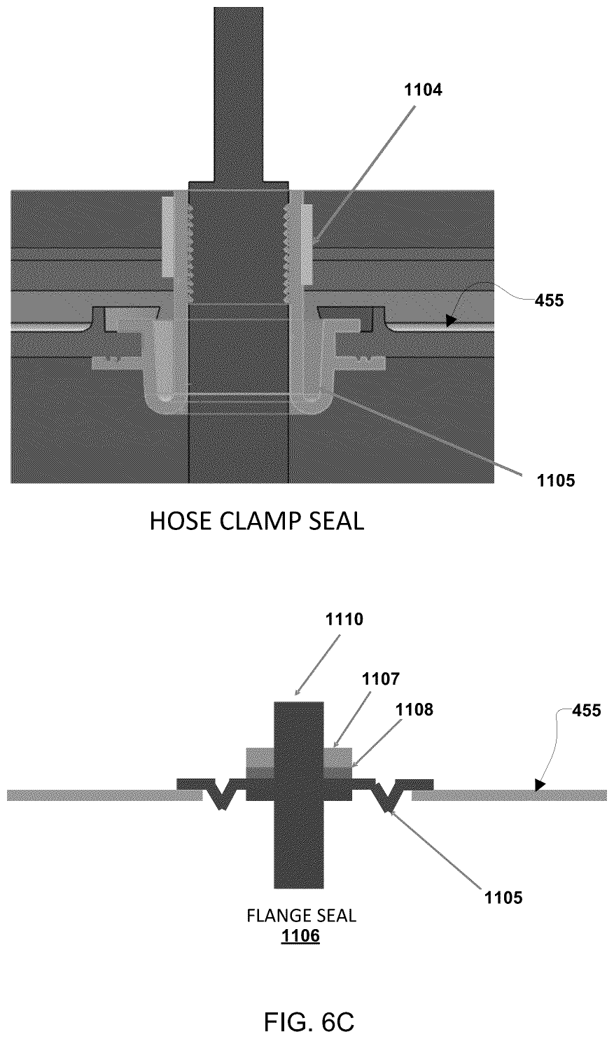

Referring now to FIGS. 1-6B, in various embodiments, passthrough portions of the lid 455 may be formed of dissimilar plastics. One approach to sealing the passthroughs may include a nested plastic cup in the respective plastic parts with epoxy 1102 therebetween to create a sealed passthrough through the lid 455 of the vessel 401. The approach shown in FIG. 6A may be a nesting trough design that provides a potting reservoir between the lid 455 and a cathode air tube 1103, with little or no need for a secondary dam to reduce the likelihood of leakage during the potting process. This feature also facilitates sealing while having access only to the top face of the lid-which provides flexibility in the order of operations of assembling the electrochemical cell 400. Holes in the lid 455 trough may provide access points for potting the epoxy 1102 into the lower trough. The epoxy 1102 may seal the lid 455 and the cathode air tube 1103 together with little or no risk of seeping into the cell area below.

FIG. 6C is a schematic representation of an implementation including a bellows feature to seal the lid 455. In some instances, a low durometer thermoplastic elastomer (TPE) may be overmolded to hard plastic of the lid 455 to provide positioning flexibility between subcomponents of the electrochemical cell and the lid 455. A bellows 1105 in the TPE may facilitate moving a busbar of the electrochemical cell freely with respect to the lid 455 with little or no transfer of mechanical loads through the bellows 1105. The TPE also, or instead, may act as a gasket material, facilitating mechanical sealing between the TPE and the busbar with a radial hose clamp seal 1104 and/or a flange seal 1106 including a nut 1107, washer 1108, and a threaded stud with shoulder 1110.

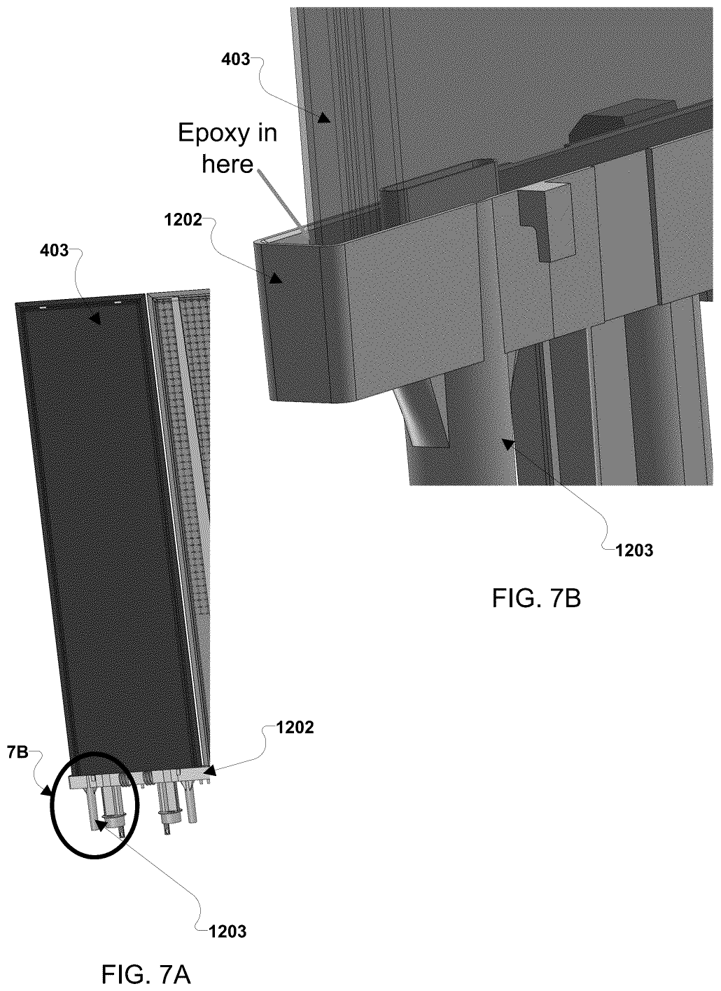

Referring now to FIGS. 7A and 7B, the GDE 404 may be sealed in some instances. For example, the GDE 404 may include a plastic containment piece 1202. The GDE 404 may be an electrode pocket with an open cavity area internal to the GDE 404 and into which air may be passed. During construction of the GDE 404, the GDE 404 may be inverted relative to its operational orientation and inverted epoxy sealing of the top edge of the GDE 404 may be performed to facilitate air passthrough to the active area of the GDE 404 after construction. The GDE 404 pocket may be sealed on the top and final edge by an epoxy potting process that occurs inverted to the operational mode of the GDE 404. The liquid level may fall high enough to wet the electrode area and seal it, and the plastic containment piece 1202 may define passages 1203 to direct air into and out of the GDE 404 that is otherwise sealed.

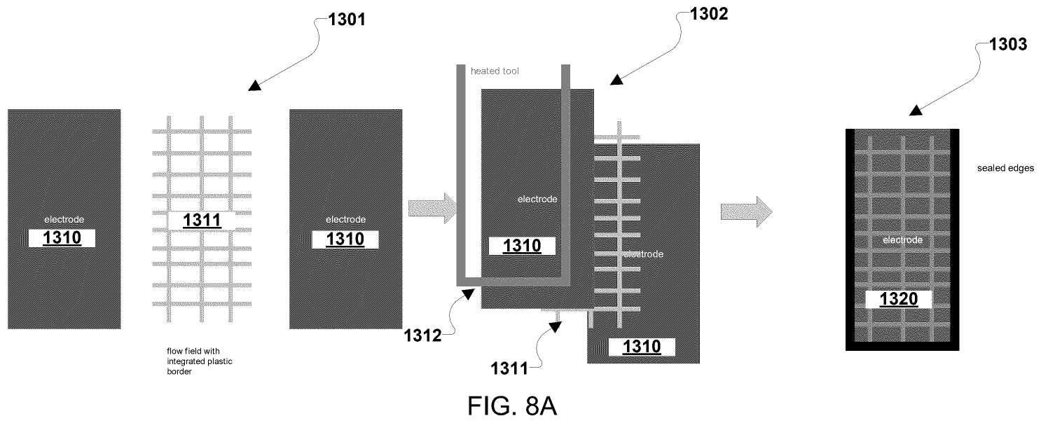

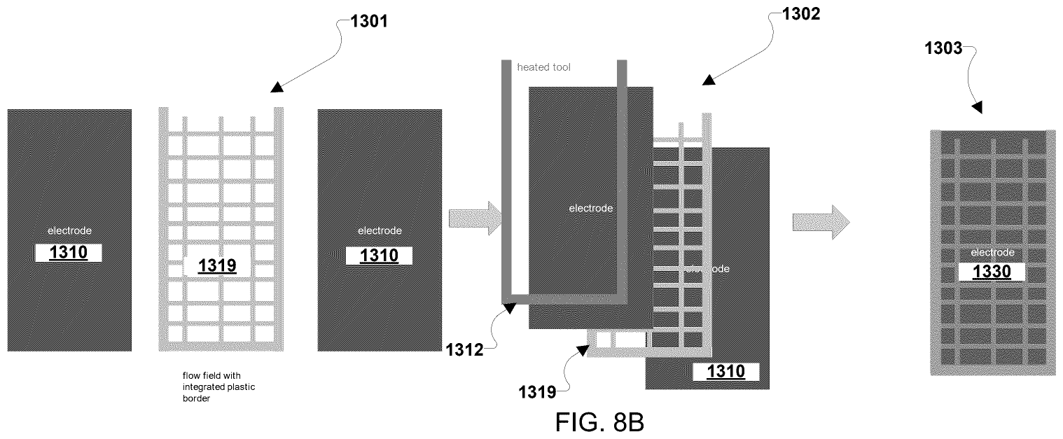

FIG. 8A is a schematic representation of an exemplary process for pressing a flow field 1311 in place during seal lamination of an electrode (e.g., the GDE 404 of FIG. 4B). For example, a flow field may be installed in a bifacial electrode assembly (e.g., the GDE 404 of FIG. 4B) as electrodes are sealed together. Positioning the flow field 1311 between two separate electrode sheets 1310, and applying heat and/or pressure to seal the edges around the flow field 1311 on three sides. Back layers of the electrodes may seal to themselves. For example, in a first step 1301, two separate electrode sheets 1310 may be provided along with a flow field 1311, and the flow field 1311 may be arranged between the two separate electrode sheets 1310. In a next step 1302, a heated tool 1312 may be pressed to the two separate electrode sheets 1310 aligned over one another such that the two separate electrode sheets 1310 are melted together at three sides to form sealed edges and for a bifacial electrode assembly 1320 (e.g., the GDE 404) at step 1303.

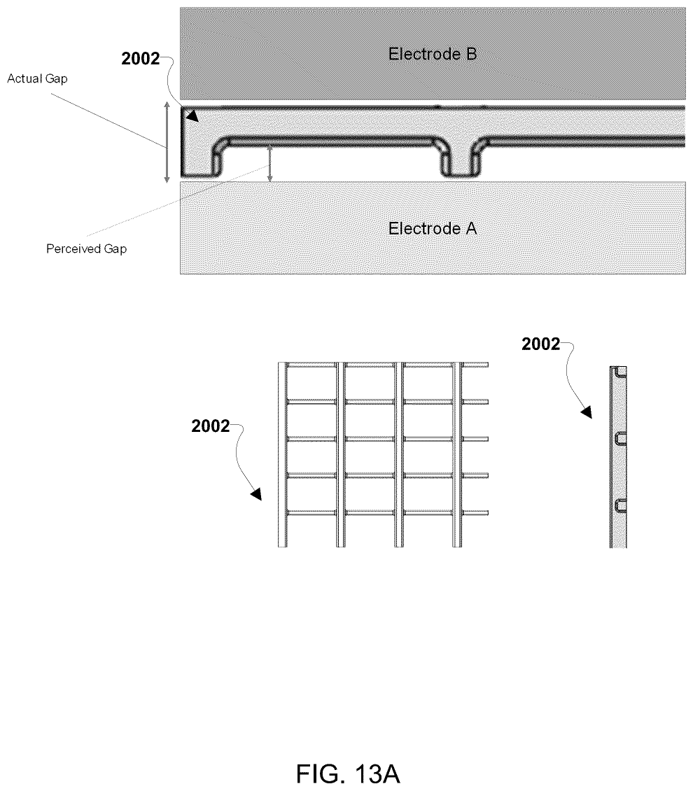

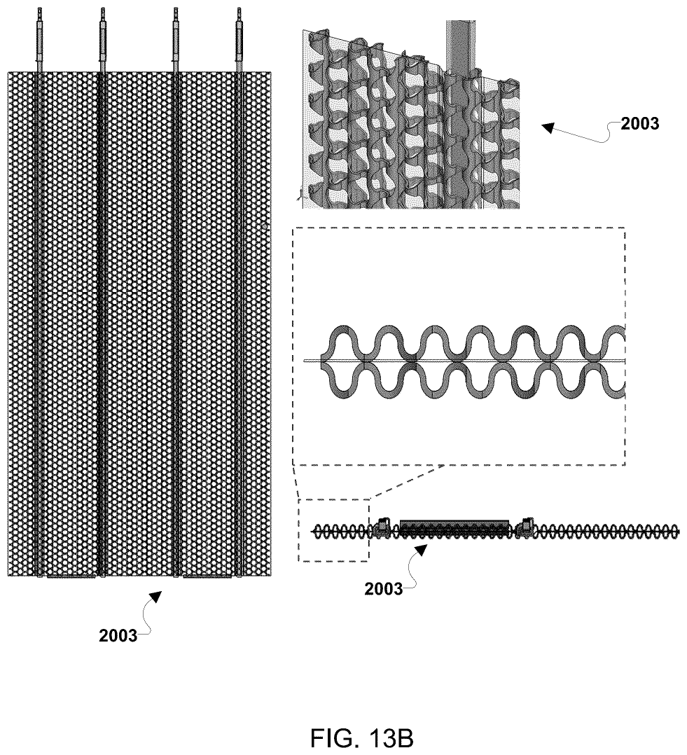

FIG. 8B is a schematic representation of another exemplary process for pressing an air flowfield in place during seal lamination of an electrode (e.g., the GDE 404 of FIG. 4B). The exemplary process of FIG. 8B is similar to the exemplary process shown in FIG. 13A, except the exemplary process shown in FIG. 8B includes using a flow field 1319 with an integrated boarder that overlaps the seal between the two separate electrode sheets 1310. According to this approach, heat and/or pressure may be applied by the tool 1312 to seal the edges around the flow field 1319, and a plastic border of the flow field 1319 may act the sealing medium to form a bifacial electrode assembly 1330.

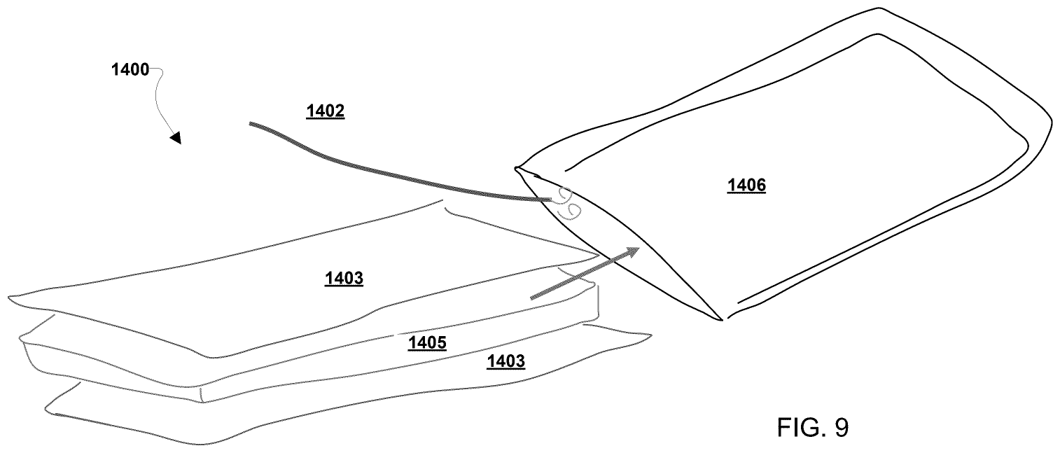

FIG. 9 is a schematic representation of an exemplary method 1400 for inserting a flow field 1405 into a pre-sealed electrode assembly 1406 to form an electrode (e.g., the GDE 404 of FIG. 4B). For example, a pre-sealed electrode assembly 1406 with three seams sealed to form a pocket may have a flow field 1405 installed according to the exemplary method 1400 by placing slip sheets 1403 of low surface energy plastic on either side of the flow field 1405. Compressed air from an air line 1402 may be blown into the pre-sealed electrode assembly 1406 such that the pocket formed by the pre-sealed electrode assembly 1406 may expand and the slip sheets 1403 and the flow field 1405 may be inserted into the pocket of the pre-sealed electrode assembly 1406. The slip sheets 1403 may be removed after installation such that only the flow field 1405 is left in place in the pocket defined by the pre-sealed electrode assembly 1406.

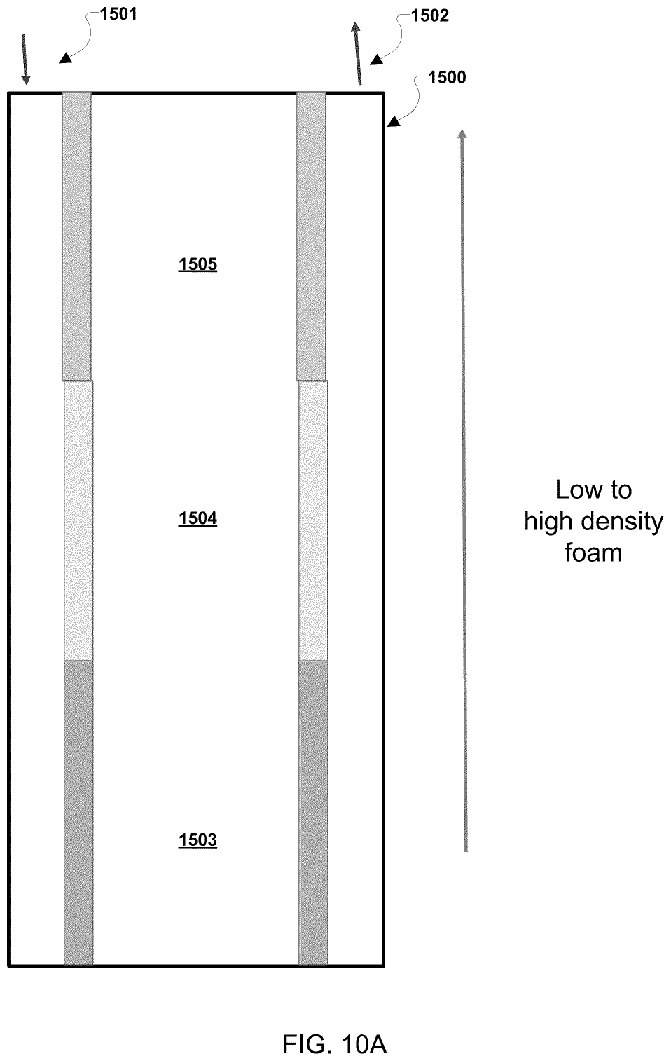

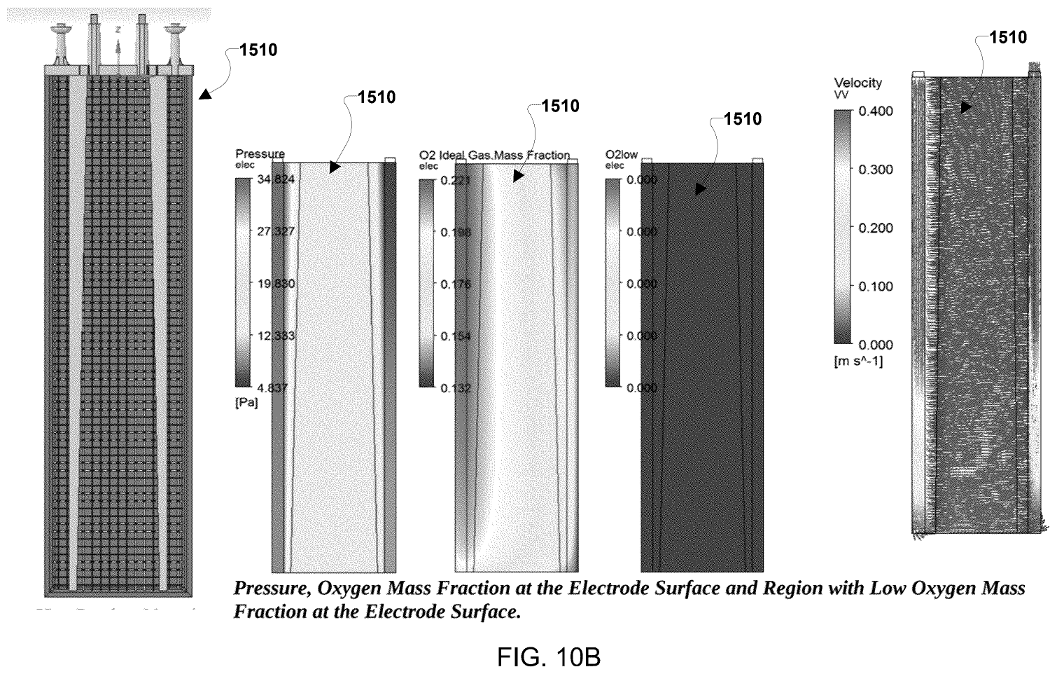

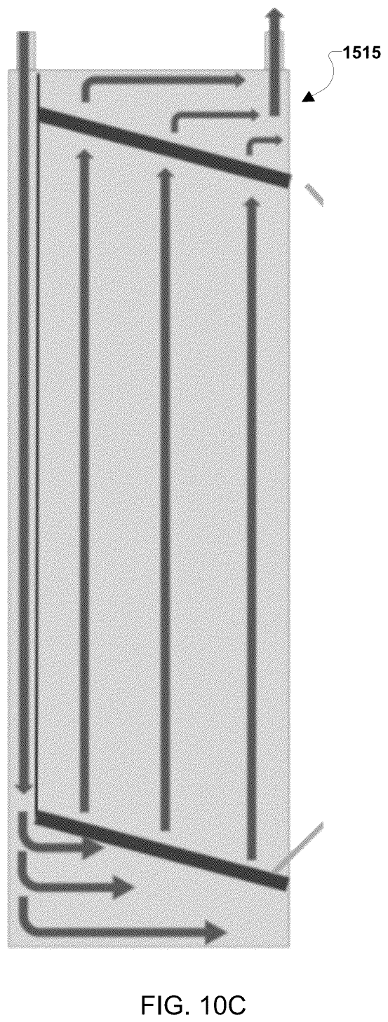

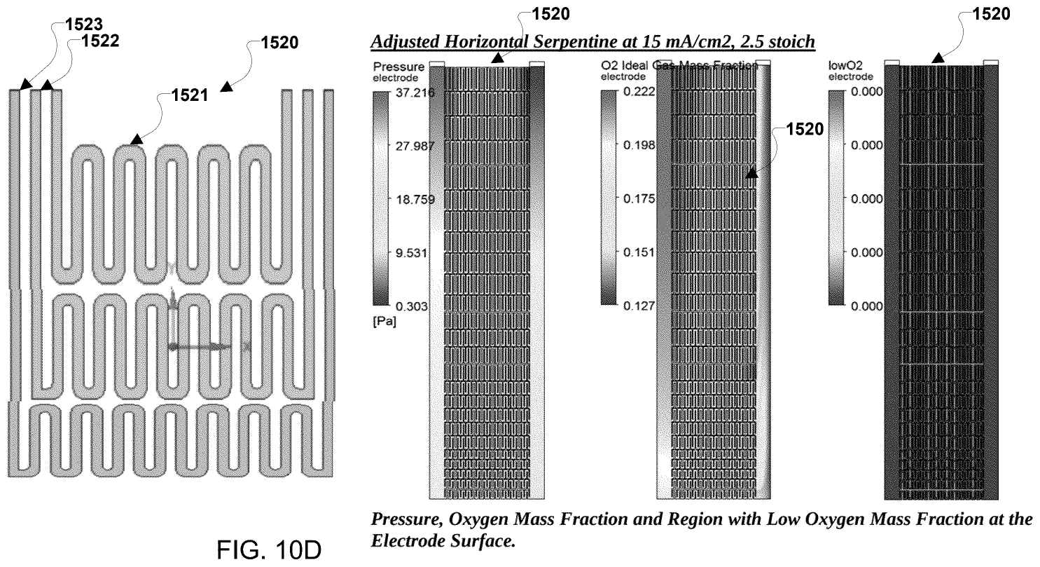

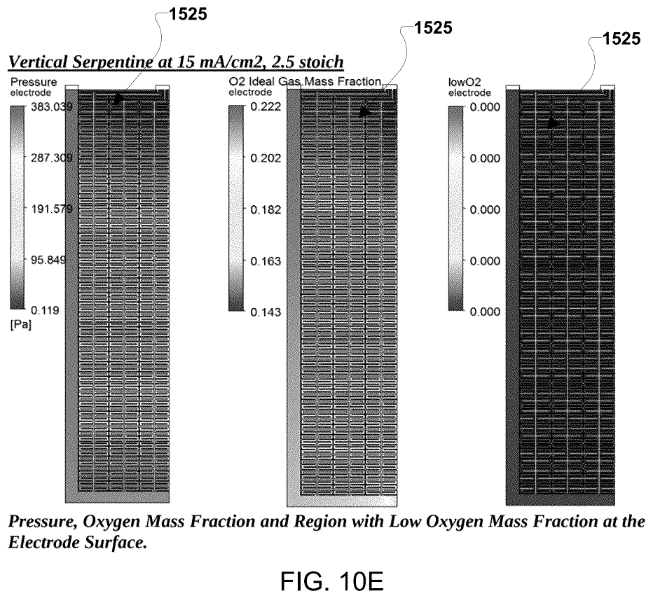

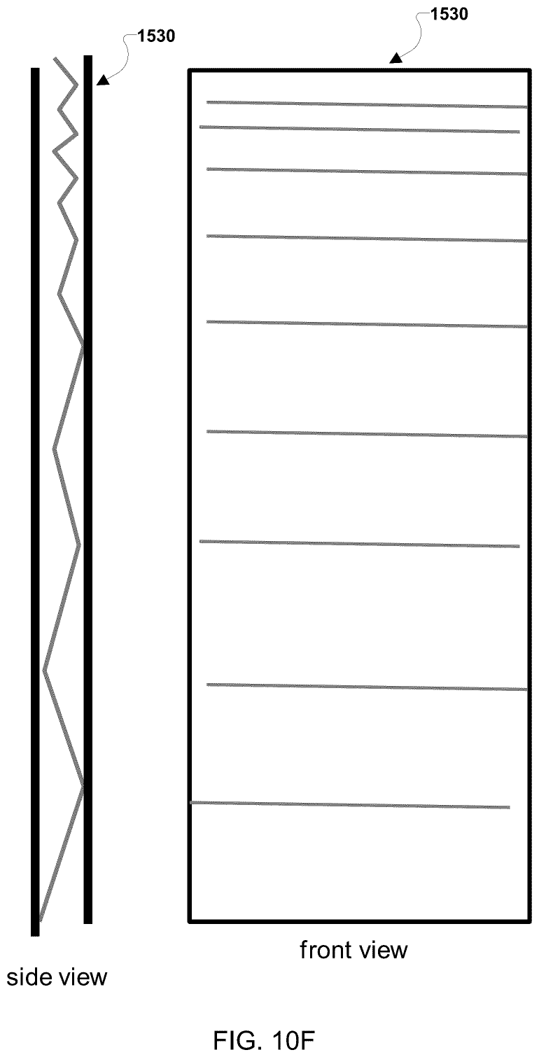

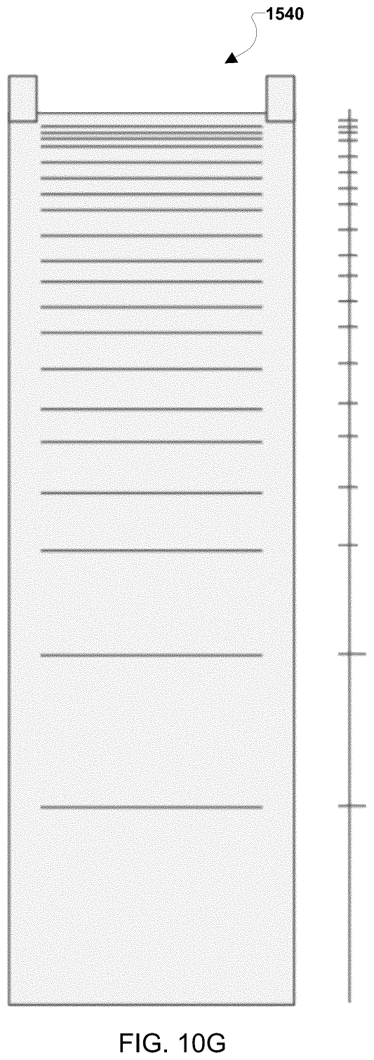

Referring now to FIG. 10A, the flow field 1500 may include porous media such that an electrode (e.g., the GDE 404 of FIG. 4B) may be formed with a low pressure, high uniformity flow between two electrode plates (e.g., between the first portion 404a of the GDE 404 and the second portion 404b of the GDE 404 of FIG. 4C and/or between the first portion 404a′ and the second portion 404b′ of the GDE 404′ of FIG. 4D). In the flow field 1500, air may be substantially uniformly distributed across a long and narrow active area of the electrode, using symmetrical stacks of open cell foam 1503, 1504, 1505 of varying porosities to facilitate controlling pressure drop across the surface. For example, the open cell foam 1503 may have lower density than the open cell foam 1504, and the open cell foam 1505 may have a higher density than each of the open cell foam 1503 and the open cell foam 1504. Air may enter the flow field 1500 at an inlet opening 1501 and exit the flow field 1500 from an outlet opening 1502 after passing through the open cell foam 1503, the open cell foam 1504, and/or the open cell foam 1505. The flow field 1500 may also, or instead, mechanically and/or electrically isolates the two faces of the electrode from one another, providing a mechanical cavity for air to access the electrode. In instances in which the flow field 1500 is formed of foam, the flow field 1500 may include pins therein to keep the two faces of the electrode from touching one another.

FIG. 10B shows computational fluid dynamic/finite element analysis simulation results of a flow field 1510 in which air is uniformly distributed across a long, narrow active area of an electrode (e.g., the GDE 404 of FIG. 4C and/or the GDE 404′ of FIG. 4D) using two symmetrical opposing strips of filter felt with a tapered geometry to balance pressure drop across the inlet to the outlet of the electrode.

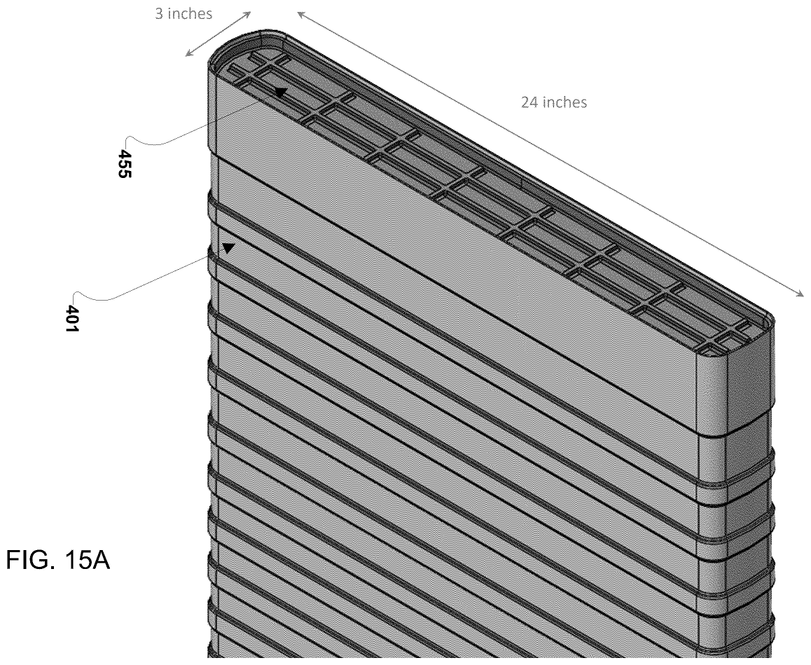

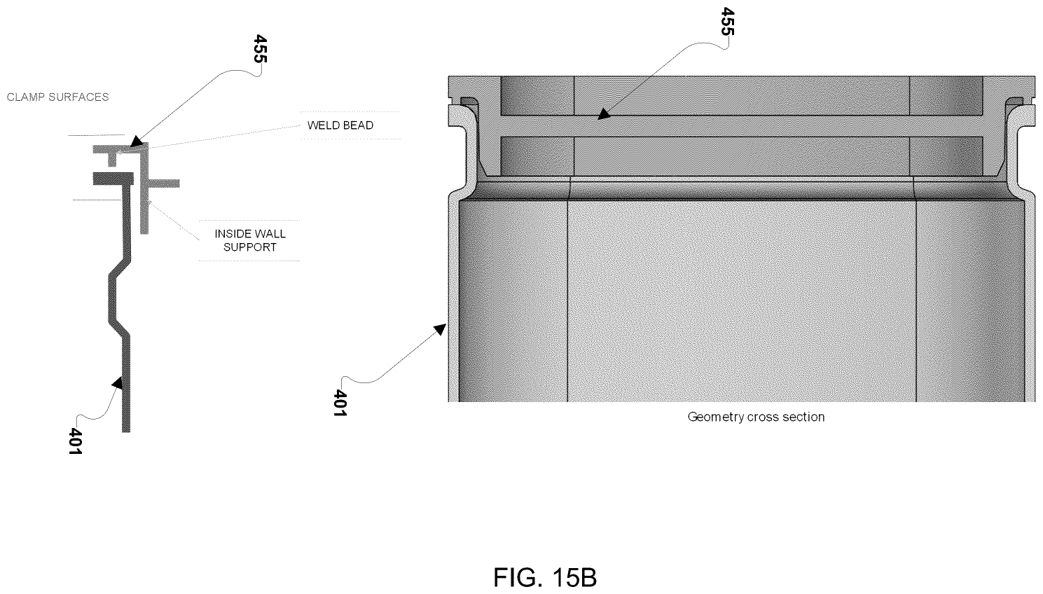

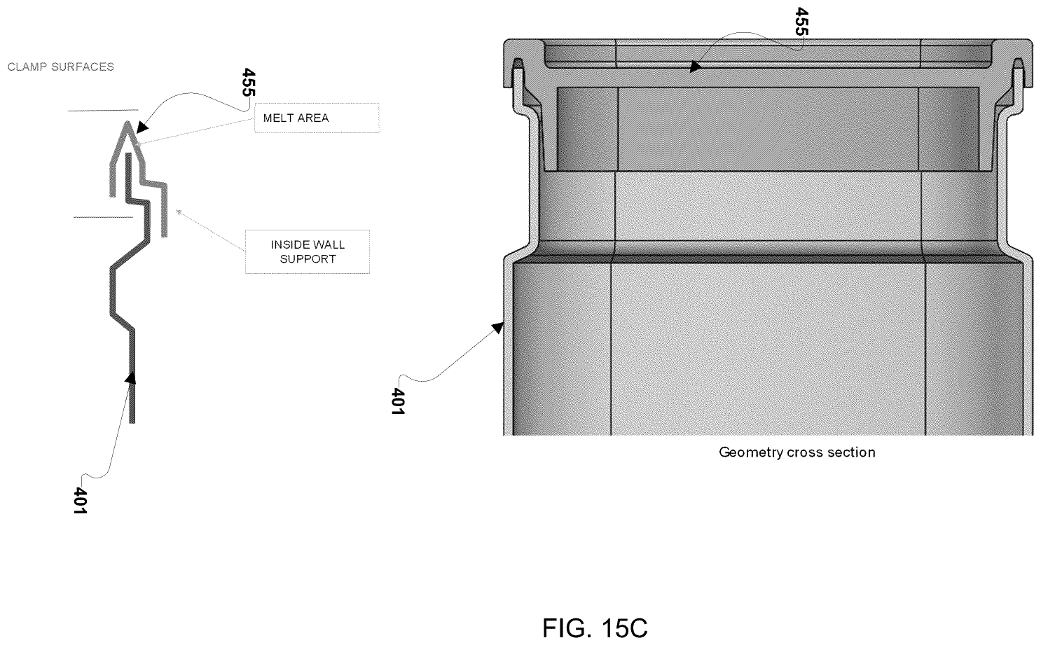

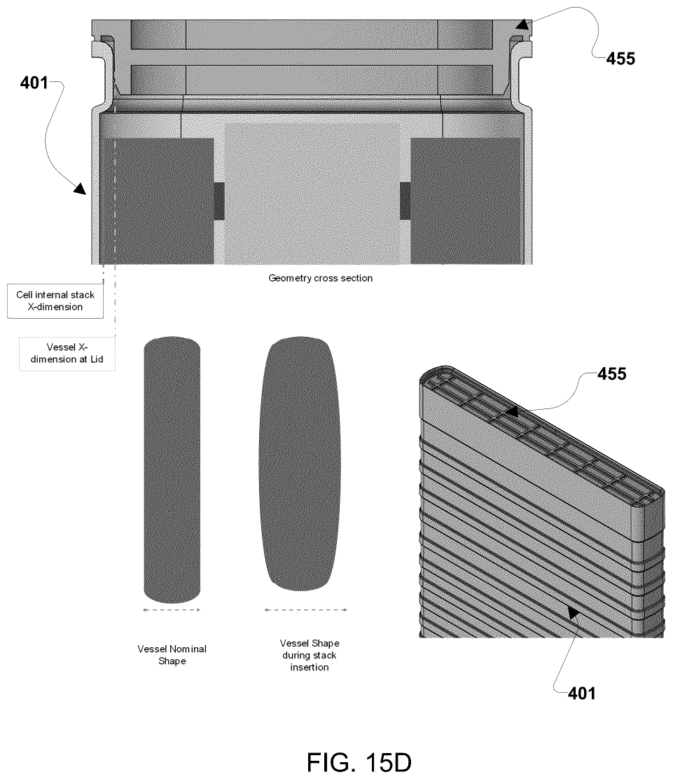

FIG. 10C is a schematic representation of a flow field 1515. Generally, the flow field 1515 is similar to the flow field 1510 (FIG. 15B), except the flow field 1515 uses a vertical feed and laterally positioned porous media strips to control and distribute air flow.

FIG. 10D shows computational fluid dynamic/finite element analysis simulation results of a flow field 1520 having a low pressure and high uniformity and formed using horizontal serpentine channels 1521, 1522, 1523 of varying heights. The flow field 1520 may substantially uniformly distribute air across a long and narrow active area of an electrode (e.g., such as between the first portion 404a of the GDE 404 and the second portion 404b of the GDE 404 in FIG. 4C and/or between the first portion 404a′ and the second portion 404b′ of the GDE 404′ in FIG. 4D) using the horizontal serpentine channels 1521, 1522, 1523, which may be symmetrically stacked and have decreasing height from top to bottom to achieve a uniform path length from inlet to outlet across the entire surface. The flow field 1520 may also, or instead, be resistant to flooding in that an electrolyte in the bottom of the flow field 1520 may not choke flow to the entire electrode.

FIG. 10E shows computational fluid dynamics/finite element analysis simulation results of a flow field 1525 including vertical serpentine channels fed by a vertical inlet running from the top of the flow field 1525 to the bottom of the flow field 1525. Air may be fed down to the bottom of the flow field 1525 and dispersed across the vertical serpentine channels across the main portion of the active area up to the outlet.

FIG. 10F is a schematic representation a long, narrow active area of an electrode including accordion folds of increasing height from top to bottom to form a flow field 1530. Smaller, more restrictive channels are created by bends toward the top of the active area, whereas more open flow occurs at the bottom of the flow field 1530.

FIG. 10G is a schematic representation of a long, narrow active area of an electrode including a ladder structure having increasing spacing from the top to the bottom of the electrode to form a flow field 1540.

Using less inactive material in each electrochemical cell helps decrease the system cost without losing any performance. A vessel for an electrochemical cell serves the dual purpose of isolating instances of electrochemical cells from one another, and providing the structure to hold cell shape of each instance of the electrochemical cell. The amount of material needed to fulfill this functionality can result in large costs associated with inactive material. By moving the structural functionality from the level of individual instances of the electrochemical cell to the level of the module, the sole purpose of the vessel may become providing electrical insulation. This can be achieved, for example, by using thin plastic bags to house each electrochemical cell, with structural end walls to sandwich the bags together. This decreases the amount of material needed, thereby decreasing overall cost.

Electrodes in the vessel of an electrochemical cell may require electrical isolation from each other. Each electrode operates at a different potential. Some electrodes cannot operate at the same potential as others in the system. If an electrode A is not compatible with the potential of electrode B, shorting of the two electrodes may result in degradation of either electrode. During cycling, some electrodes produce bubbles which can coalesce and cause blocking between the electrodes. Blocking between electrodes can increase ohmic resistance, cause mass transport issues, dry out an electrode resulting in loss of performance, locally deteriorate the surface of an electrode, and/or have other negative effects to the cell. Additionally, or alternatively, certain electrode operating potentials may lead to the degradation of plastics used as separator materials and can lead to shorting.

Various embodiments may include a standoff and separator to reduce the likelihood of shorting between the charge electrodes (e.g., the first anode assembly 402a and the second anode assembly 402b and either one of the first OEE 403a and the second OEE 403b).

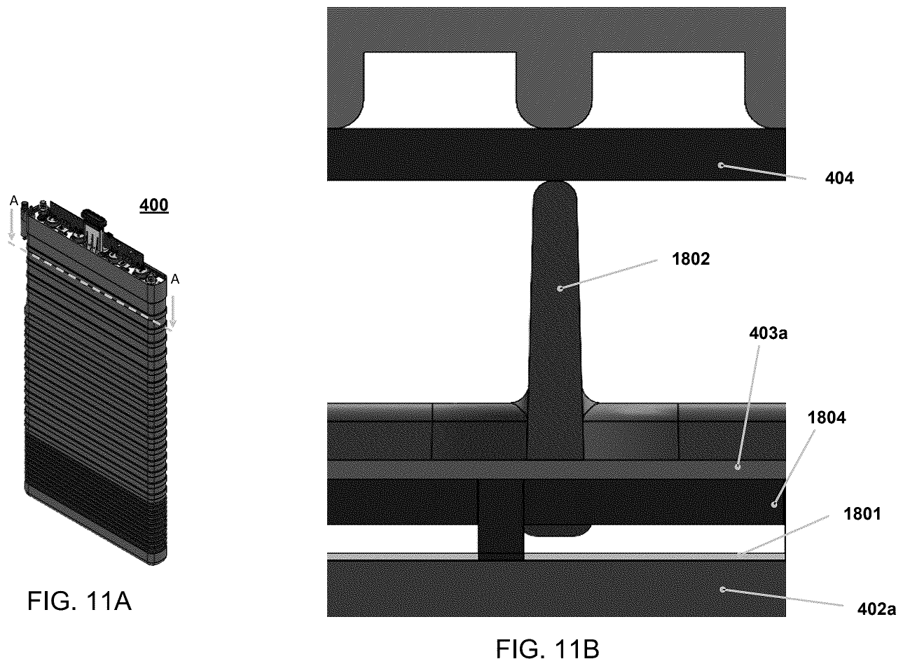

Referring now to FIGS. 11A and 11B, the electrochemical cell 400 may include a separator 1801, a first standoff 1802, and a second standoff 1804. The first standoff 1802 may be disposed between the OEE and the anode, and the second standoff 1804 may be disposed between the GDE 404 and the first OEE 403a. The separator 1801 and the second standoff 1803 may be disposed between the first OEE 403a and the first anode assembly 402a. The separator 1801 reduces the likelihood of shorting between the first anode assembly 402a and the first OEE 403a. The second standoff 1803 may provide space for oxygen bubbles generated during charge to egress vertically from the active surface. The material of the second standoff 1803 may be compatible with the potential of the first OEE 403a. The second standoff 1803 between the separator 1801 and the first OEE 403a may eliminate, or at least reduce, material compatibility concerns with the separator 1801 and the first OEE 403a. The first anode assembly 402a and the first OEE 403a are shown, but it shall be understood that analogous standoffs and separators may be additionally or alternatively be disposed between the GDE 404 and the second OEE 403b and between the second OEE 403b and the second anode assembly 402b. For the sake of clear illustration and efficient description, these are not described separately.

In certain implementations, the separator 1801 may be a sheet of separator material. For example, the material of the separator 1801 may be ionically conductive, allowing ions to pass through freely, but electrically insulative to prevent electrical shorting between electrodes. Further, or instead, the material of the separator 1801 may allow ions to pass while not allowing electrolyte additive species to pass. Further, or instead, the separator 1801 may be impermeable to bubbles generated by the first OEE 403a and/or the GDE 404 such that the bubbles do reach the first anode assembly 402a. Likewise, the material of the separator 1801 may be impermeable to bubbles from the first anode assembly 402a such that these bubbles do not reach the first OEE 403a and/or the GDE 404. Further, or instead, while the separator 1801 is shown disposed on the first anode assembly 402a, it shall be appreciated that the separator 1801 may be supported on the first OEE 403a and/or on one or more structural components of the electrochemical cell 400. Further, or instead, the separator 1801 may disposed between the GDE 404 and the first OEE 403a. Still further, or instead, it shall be understood that there may be more than one instance of the separator 1801 disposed within the electrochemical cell 400, as may be useful for limiting movement of bubbles and/or electrolyte additive species within the electrochemical cell 400 while allowing ions to move within the electrochemical cell 400.

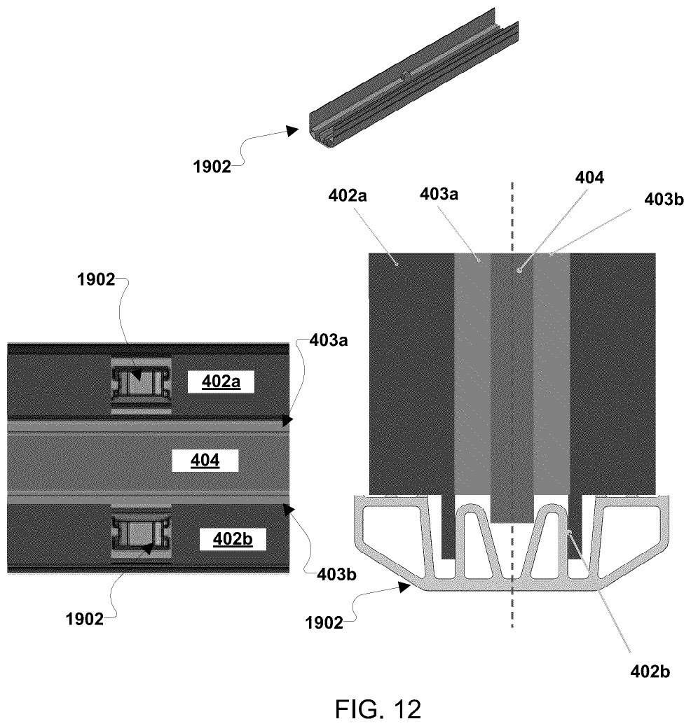

Referring now to FIG. 12, electrodes may be positioned in a vessel of an electrochemical cell in a manner that supports cell performance. For example, an electrode holder 19 may support portions of one or more electrodes (e.g., the GDE 404, the first anode assembly 402a, the first OEE 403a, the second anode assembly 402b, and the second OEE 403b in the vessel 401 of FIG. 4B). The electrode holder 19 may be, for example, extruded. Further, or instead, the electrode holder 1902 may datum the positions of the first anode assembly 402a and of the second anode assembly 402b at the bottom of the electrochemical cell. Walls at the bottom of the electrode holder 1902 may limit the distance the first anode assembly 402a and the second anode assembly 402b may translate towards the cathode stack to set the electrode spacing and reduce the likelihood of crushing the cathodes—the GDE 404, the first OEE 403a, and the second OEE 403b.

In some embodiments, a metal-air battery, such as an iron-air battery, may be constructed without the use of a separator, and electrodes in the metal-air battery may be separated to prevent shorts. In some embodiments, physical design of the electrochemical cell may provide required electrode gaps without the use of specific separator materials between electrodes. Especially in iron-air batteries where the electrode gap required may be millimeters in distance, separator-less configurations may be advantageous.

Referring now to FIG. 13A, a mesh standoff 2002 may be disposed between two electrodes—which are shown as electrode A and electrode B and shall be understood to include any two electrodes described herein. The gaps between the electrodes function to prevent electrical shorting. The gap also defines the minimum length that must be closed to cause a short. Using the mesh standoff 2002 between electrode A and electrode B defines the gap between the active faces. The vertical members of the mesh standoff 2002 may be larger than the horizontal members of the mesh standoff 2002. This allows for the gap between the electrode A and the electrode B to be larger than the perceived gap that an item would need to bridge to short the electrodes.

Referring now to FIG. 13B, a corrugated standoff 2003 may be used to separate two electrodes (e.g., any two electrodes described herein). The holes and spacing of the corrugations of the corrugated standoff 2003 may make a tortuous path for a shorting body while the planar view has a high open area to reduce the likelihood of occlusion between electrodes.

Referring now to FIGS. 13A and 13B, standoffs may aid in bubble management. During operation bubbles are generated within the electrochemical cell. These bubbles are products of cycling but can negatively impact performance of the electrochemical cell. For example, bubbles can coalesce and cause blockages in the cell, dry out the electrodes leading to degradation, and potentially cause surface damage to specific anodes. Standoffs, used for electrical isolation, may facilitate managing the bubbles. For example, the corrugated standoff 2003 may provide vertical channels for bubbles to egress out of the electrochemical cell. As another example, the horizontal members of the mesh standoff 2002 may be sub-flush from the vertical members to define channels for bubbles to egress out of the electrochemical cell.

Current generated from the electrode must be carried out of the electrochemical cell while limiting ohmic losses, minimizing non-uniformity of current distribution, and optimized for cost. Various embodiments may include electrode current collection.

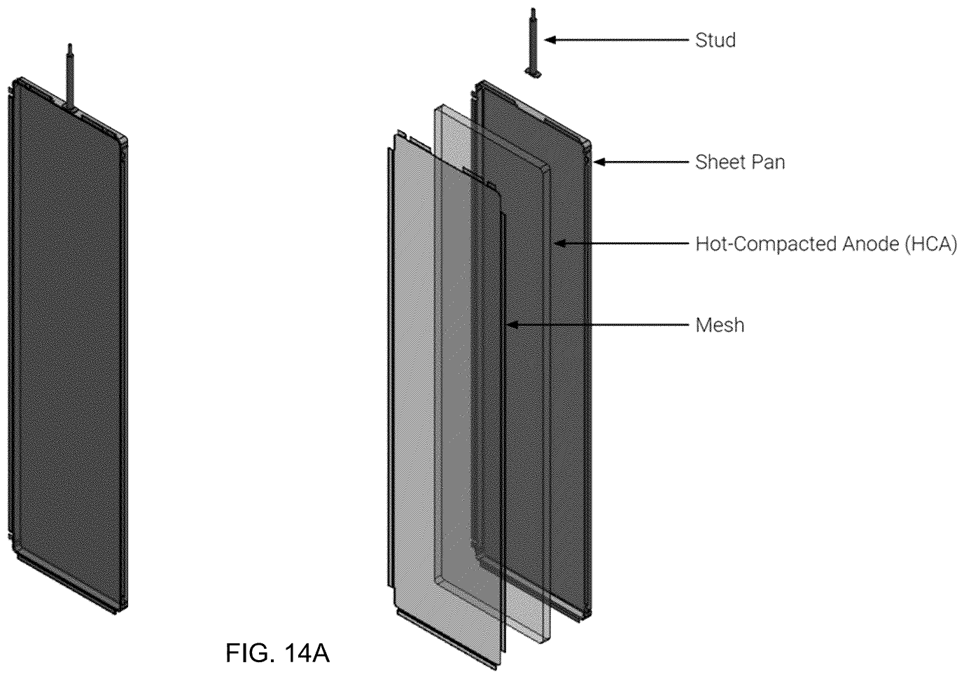

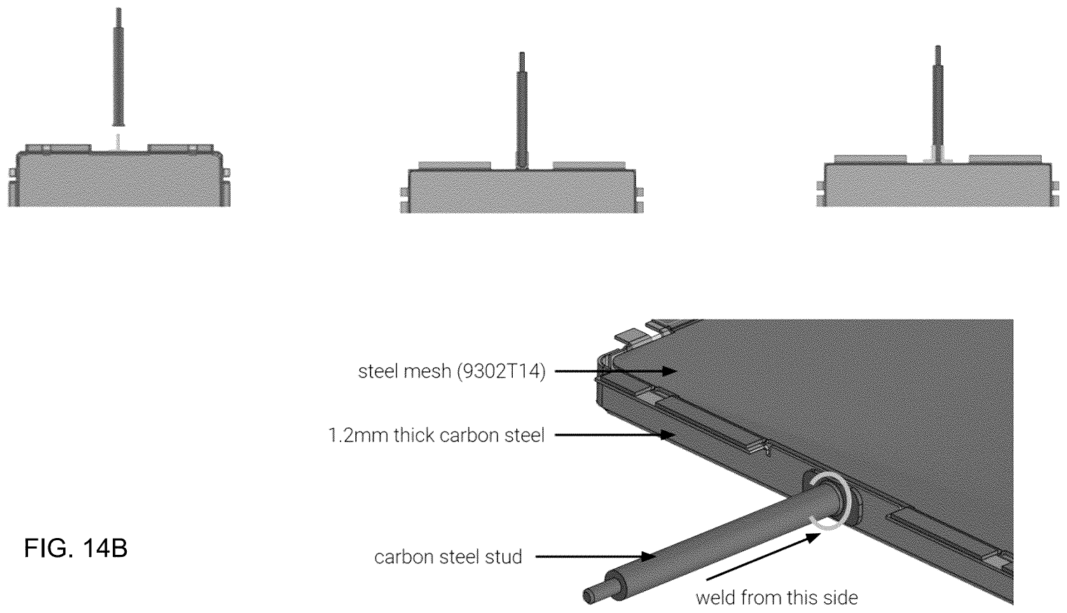

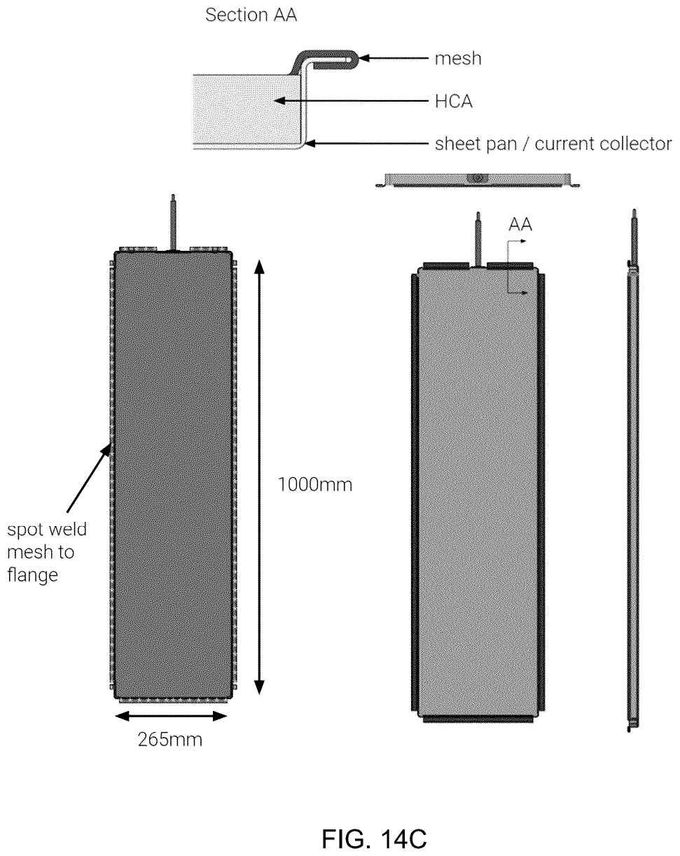

FIGS. 14A-C are schematic representations of aspects of anode assemblies (e.g., the first anode assembly 402a and/or the second anode assembly 402b in FIG. 4B).

Referring now to FIG. 14A, an anode assembly may be a hot compressed anode (HCA) structure. Structure and current collector of the HCA structure may be made of sheet metal stamped in a “pan-like” shape, with the solid backing facing away from the cathodes in the electrochemical cell. Busbars may be welded to the top-most edge of the sheet pan. Advantages of such “sheet pan” designs may include: that the pan may be pre-filled (prior to pressing & sintering) with anode material (e.g. powdered iron, DRI, additives) without a secondary form; that the back of pan may be nonporous, which may be beneficial for electrical conductivity (vs perforated or expanded); that solid steel sheet backing & sides may protect the anode assembly from handling-related damage; and/or that the solid top may provide a surface for welding busbars.

Referring now to FIG. 14B, a busbar may be attached to the top of the pan to pass current from the electrode through the lid. A round low-carbon steel busbar may be used because it is: easily welded to the pan (like metals); a relatively low-cost conductor (on par with Cu conductors); electrochemically compatible at anode potentials, therefore does not need to be encapsulated; structurally robust for lifting and moving the anode and the electrochemical cell; and easily sealed at the lid with mechanical seals (e.g. gasket & hose clamp). Methods of busbar attachment may include: resistance stud welding; threaded rod+nut in the sheet pan; and/or spot welding to tabs on the sheet pan.

Referring now to FIG. 14C, mesh/containment attachments for an anode may include a porous steel sheet (typically perforated or expanded) to contain any >1 mm sized particles of the anode which may become dislodged. These particles may cause shorts or clogs in the watering system.

The chemical reaction within an alkaline electrochemical cell may result in electrolyte mist populating the cell headspace. This mist can lead to conductive electrolyte working its way out of the cell and contaminating the surrounding area. To reduce the likelihood of this creep, creating a hermetic seal between the lid and the vessel may be critical to the functionality of the electrochemical cell. However, creating this seal may be difficult due to the length of the seam.

FIGS. 15A-D are schematic representations of aspects of lid-to-vessel sealing (e.g., sealing the lid 455 to the vessel 401 in FIG. 4B).

Referring now to FIG. 15A, the seal between the lid 455 and the vessel 401 may need to be able to account for large dimensional tolerances between the lid and the vessel due to the size of the two parts and/or the use of the lower tolerance manufacturing methods (blow molding) for cost-effective fabrication of the vessel. Clamping force needed between the lid 455 and the vessel 401 during the sealing process may need to be isolated from the walls of the vessel 401 (e.g., in instances in which the walls of the vessel 401 are too flimsy) and/or from other components of the electrochemical cell subcomponents. Further, or instead, features of the seal between the lid 455 and the vessel 401 may need to fit within the existing X, Y, and Z bounding box of the vessel 401.

Referring now to FIG. 15B, welding (e.g., hot gas welding or laser welding) may be used to seal the lid 455 to the vessel 401. Notable features of such an implementation may include: a weld bead to make up for any tolerancing between the two parts; a flange in the vessel 401 providing a clamping surface to decrease the likelihood that any clamping during the weld process propagates to the vessel 401; inside support wall on the lid 455 reducing the likelihood of the vessel 401 slipping during a weld process; and increased thickness of the vessel 401 at the flange point. Minimizing thickness of the vessel 401 may be critical to reducing inactive material cost of the cell. Because of this, the nominal wall thickness of the vessel 401 may be thinner than optimal for welding. By utilizing parison programming during the blow mold process, the vessel thickness may be increased in a specific height window of the vessel 401. Datuming to the top flange of the vessel 401 instead of to the bottom of the vessel 401 may remove, or at least decrease, the need for tight tolerancing on the height of the vessel 401, which may be about 1 m in some instances.

Referring now to FIG. 15C, the lid 455 may be sealed to the vessel 401 using a hot gas welding joint geometry. Notable features of such a hog gas welding joint geometry may include: the angular opening that allows for a large displacement of the top edge of the vessel 401 to account for any lack of tolerancing on that surface; the flange in the vessel 401 provides a clamping surface to reduce the likelihood of unintended propagation of clamping force down into the vessel 401; the inside support wall on the lid 455 may reduce the likelihood of the vessel 401 slipping during the weld process; and datuming to the top flange of the vessel 401 instead of to the bottom of the vessel 401 may remove, or at least decrease, the need for tight tolerancing on the height (e.g., about 1 m) of the vessel 401.

Referring now to FIG. 15D, the vessel 401 may include flexible walls to facilitate achieving large available overlap between the lid 455 and the vessel 401. Utilizing the flexible walls of the vessel 401 to achieve large available overlap between the lid 455 and the vessel 401 may be applicable to all weld geometries described herein, such as those of FIG. 15B and FIG. 15C. To facilitate optimizing footprint of the electrochemical cell, the bounding dimensions of the electrochemical cell may be driven by the dimensions of the substack (anodes+cathodes) of the electrochemical cell, with the additional area being allocated only for vessel wall thickness and cooling channels. The overlap surface between the flange of the vessel 401 and the lid 455 may be too small for reliable plastic welding. By utilizing the flexibility of the vessel 401, it may become possible to have a nominal interference between the substack and atop section of the vessel 401, as the vessel 401 can be deformed during the insertion process to allow the substack to slide in.

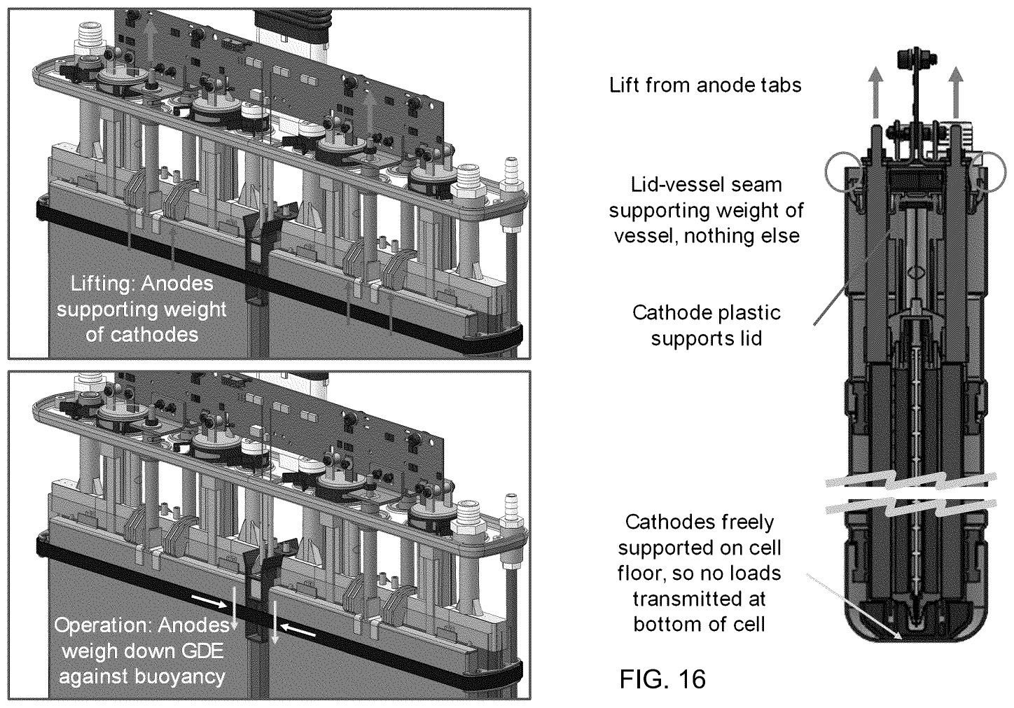

Referring now to FIG. 16, an anode (e.g., the first anode assembly 402a and/or the second instances of the second anode assembly 402b in FIG. 4B) may operate as a primary structural member for an electrochemical cell. That is, the anodes of an electrochemical may serve as the structural backbone of the electrochemical cell due to mass and rigidity relative to the other cell components. Reducing materials cost means reducing materials, and not all components and seals are capable of withstanding forces seen during lifting or operation. In the case of lifting, the electrochemical cell may be lifted by the anodes, the anodes may support the weight of cathodes through features on plastic parts of the cathode. The lid may be supported by cathode plastics, and only the vessel-to-lid seam must withstand the weight of the vessel. During operation, the weight of the anodes may counteract buoyancy force in the GDE through friction between the anodes and cathode plastics. Strapping may constrain anodes to plastics. Resulting friction to GDE plastics counteracts buoyant force.

Minimizing or reducing the inactive material used in each electrochemical cell may help to decrease the system cost without losing any performance. A typical vessel of the electrochemical cell serves the dual purposes of isolating cells from one another and providing the structure to hold the shape of the electrochemical cell. The amount of material needed to fulfill this functionality can result in large costs associated with inactive material.

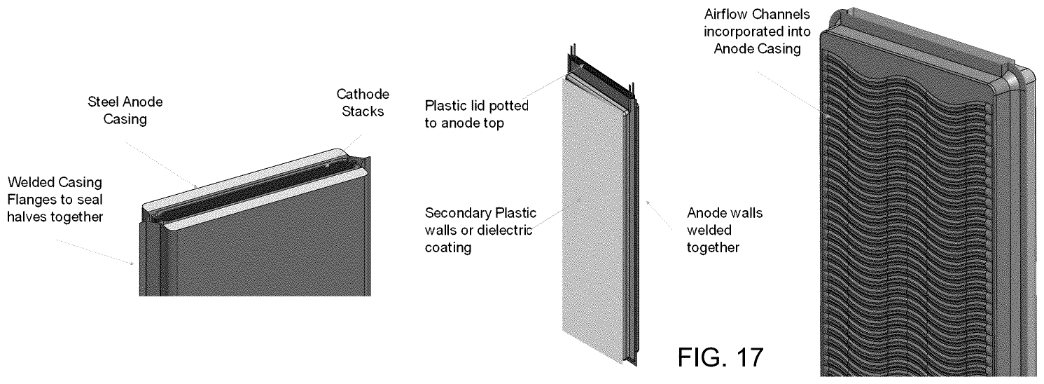

Referring now to FIG. 17, schematic representations of aspects of anodes used as cell containers are shown. The anode may include a metal, such as iron, encased in a steel pan. Utilizing the structure of the anode to fulfill the structural functionality of the vessel of the electrochemical cell, instead of relying on a separate vessel to house all of the components, may remove a large amount of inactive material from the electrochemical cell. A dielectric coating may be applied to the steel anode casing to provide electrical insulation. Cooling channels may be incorporated into the stamped vessel to fulfill thermal system airflow requirements. This may facilitate reducing costs associated with inactive cell material and part manufacturing.

Various embodiments may include blow mold designs for module cooling and structure. In various embodiments, the vessel of the electrochemical cell, may have a geometry that facilitates achieving required cell cooling. Further, or instead, the vessel may electrically insulate the electrochemical cell. The vessel may be alkaline electrolyte compatible. The vessel may define a cavity that is hermetically sealed. The vessel may withstand forces acting on the vessel, such as with a safety factor of 1.5. The vessel may restrain hydrostatic forces from the liquid electrolyte. The vessel may accommodate airflow for cooling.

In various embodiments, a vessel of the electrochemical cell may include a cooling channel geometry that changes with cell height to facilitate directing more cooling towards the top of the electrochemical cell, where the electrolyte tends to be hotter due to natural convection. Further, or instead, the changing cooling channel geometry may maximize vessel wall strength towards the bottom of the electrochemical cell where the hydrostatic loads are higher. In such embodiments, the vessel may be a multifunctional component, delivering mechanical structure, thermal cooling channels, and/or electrolyte containment.

Having described various aspects of electrochemical cells, attention is now directed to certain aspects associated with manufacturability of metal-air batteries with high energy density and reliable operation. In general, metal-air batteries (e.g., iron-air batteries) may have both large and heavy electrochemical cells, making it useful to assembly such metal-air batteries using modules for fewer and faster assembly steps. To facilitate increasing energy density of these metal-air batteries, it may be additionally useful to package components of these metal-air batteries to reduce the ratio of inactive material to active material in the metal-air battery. Further, these electrochemical cells typically use multiple cathodes for charge and discharge, which represents packaging challenges. Additional challenges may arise in designing metal-air batteries to resist the alkaline electrolyte and/or resist electrochemical creep. Various aspects of the electrochemical cell described in the following paragraphs address these and other challenges associated with manufacturability of metal-air batteries.

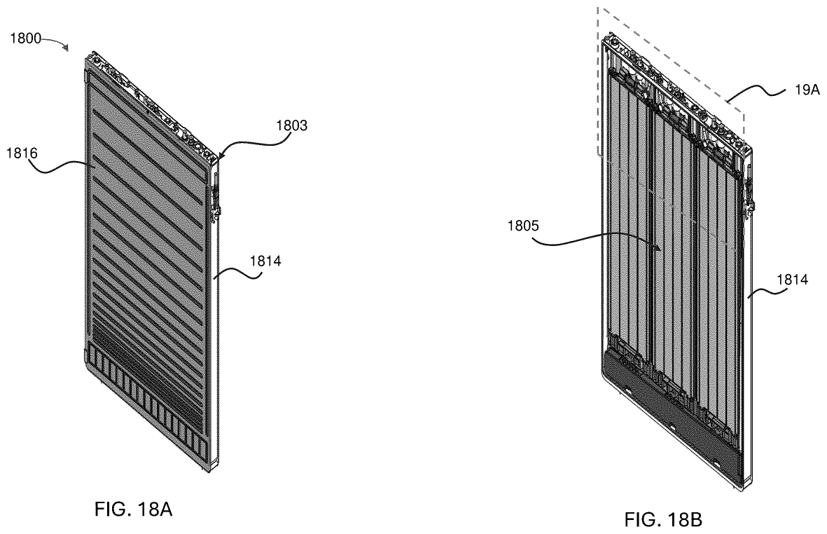

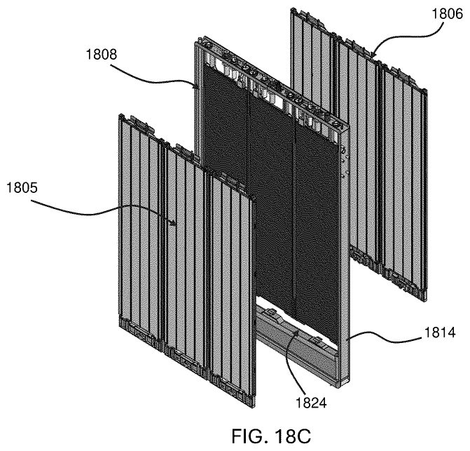

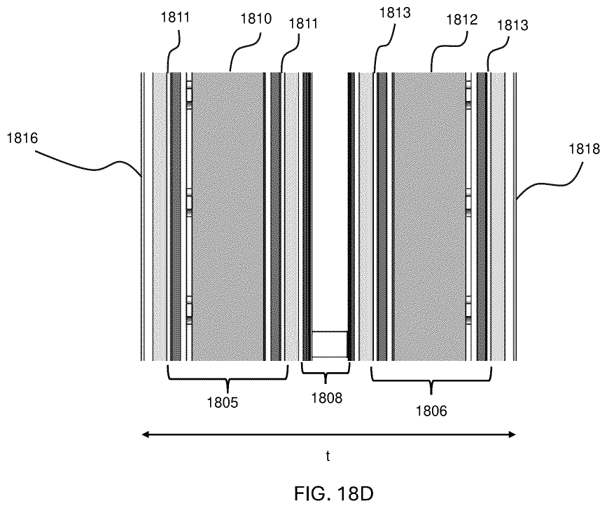

Referring now to FIGS. 18A-18D, an electrochemical cell 1800 may include a vessel 1803, a first module 1805, a second module 1806, and a gas diffusion electrode (GDE) 1808. The first module 1805 may include a first anode 1810 sandwiched between two first oxygen evolution electrodes 1811 along a thickness dimension t of the vessel 1803. The second module 1806 may include a second anode 1812 sandwiched between two second oxygen evolution electrodes 1813 along the thickness dimension t of the vessel 1803. The GDE 1808 may be disposed between the first module 1805 and the second module 1806 in the vessel along the thickness dimension t of the vessel 1803. As compared to other stack configurations of electrodes, the symmetry of the first module 1805 and the second module 1806 about the GDE 1808 may facilitate achieving higher energy density. That is, using two oxygen evolution electrodes per anode in the electrochemical cell 1800 may increase capacity and efficiency as compared to the use of a single oxygen evolution electrode per anode. Further, or instead, the symmetry of the first module 1805 and the second module 1806 may facilitate automation of fabrication and further, or instead, may protect the GDE 1808.

In general, the vessel 1803 may have a large aspect ratio (e.g., 1 m tall by 1 m wide while having a thickness dimension t of about 100 cm or less), as may be useful for achieving high energy density and cost-effectiveness. The vessel 1803 may include a core 1814, a first panel 1816, and a second panel 1818 that collectively encapsulate the first module 1805, the second module 1806, and the GDE 1808. As described in greater detail below, the first module 1805, the second module 1806, and the GDE 1808 may be connected to the core 1814, and then one or both of the first panel 1816 or the second panel 1818 may be welded to the core 1814 to achieve the encapsulation such that the first module 1805, the second module 1806, and the GDE 1808 are hermetically sealed in within the vessel 1803. As compared to blow molding a vessel having a large aspect ratio, the modularity of the vessel 1803 is amenable to cost-effective and reliable manufacturing. As an example, the core 1814 may be injection molded and each of the first panel 1816 and the second panel 1818 may be thermoformed. Further, the assembly of the electrochemical cell 1800 using the core 1814 that is then welded to the first panel 1816 and the second panel 1818 to form a hermetic seal addresses challenges that may otherwise arise with respect to achieving a robust seal between multiple plastic parts. That is, the first module 1805, the second module 1806, and the GDE 1808 may be supported in place by the core 1814 alone such that welding of the first panel 1816 and the second panel 1818 to the core 1814 may be carried out independently from assembly of the components within the vessel 1803. For example, the first anode 1810 and the second anode 1812 may be load-bearing members within the vessel 1803 such that the core 1814 may be supported by the first anode 1810 and the second anode 1812 as the first panel 1816 and the second panel 1818 are welded to the core 1814. Stated differently, the load-bearing provided by the first anode 1810 and the second anode 1812 installed on the core 1814 reduce or eliminate any load on the first panel 1816 and the second panel 1818, thus facilitating the modular assembly of the vessel 1803 while also achieving a robust hermetic seal.

In certain implementations, the first module 1805 and the second module 1806 may be portable independently of one another such that the first module 1805 and the second module 1806 may be connected to the core 1814 in respective assembly steps. To facilitate such assembly, each of the two first oxygen evolution electrodes 1811 may be heat staked to the first anode 1810 in the first module 1805 and each of the two second oxygen evolution electrodes 1813 may be heat staked to the second anode 1812. Such heat staking may be useful for maintaining appropriate dimensional fidelity of these modules as each of these modules is secured to the core 1814.

In some implementations, all instances of a fluid port 1820 into the vessel 1803 and all electrical connections into the vessel 1803 may pass through the core 1814 of the vessel 1803. This may be useful for modular assembly of the vessel 1803 by welding the first panel 1816 and the second panel 1818 to the core 1814. That is, with all fluid ports into the vessel 1803 and all electrical connections into the vessel 1803 passing through the core 1814, the process of welding the first panel 1816 and the second panel 1818 to the core 1814 to hermetically seal the vessel 1803 may be away from these fluid ports and electrical connections and, thus, less likely to adversely impact these connections.

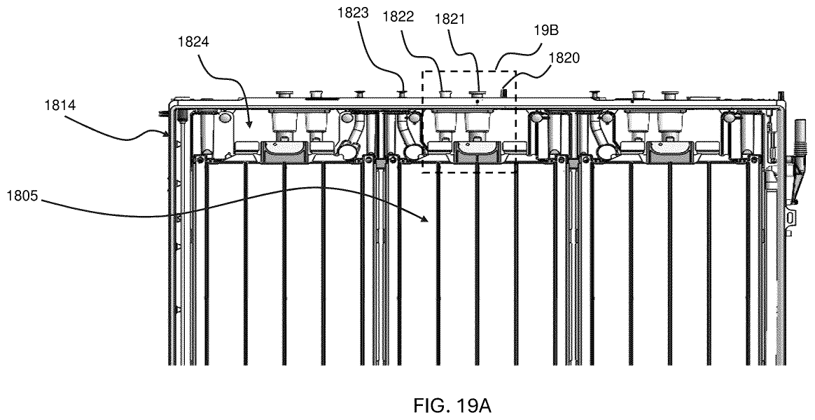

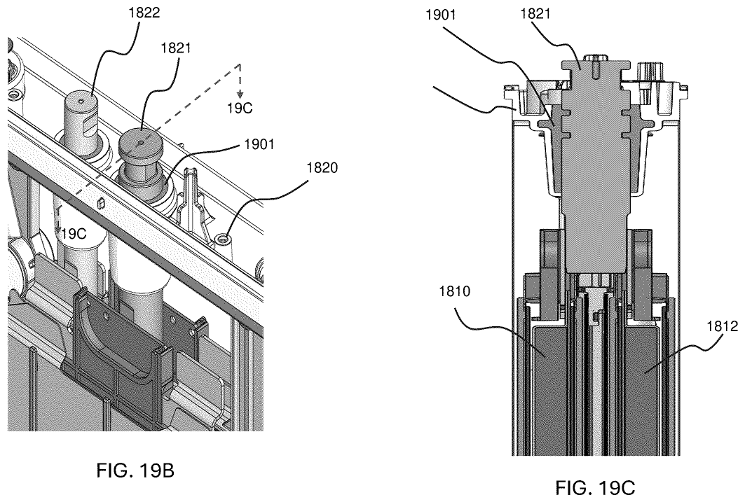

Referring now to FIGS. 18A-18D and 19A-19C, achieving efficiency in the use of material for saving weight and for reducing the ratio of inactive material to active material may include making multiple electrical connections to each terminal extending through the core 1814. For example, the electrochemical cell 1800 may include a first terminal 1821 extending through the vessel 1803 (e.g., extending through the core 1814) and into parallel electrical communication with the first anode 1810 and the second anode 1812 in the vessel 1803. Further, or instead, the electrochemical cell 1800 may include a second terminal 1822 extending through the vessel 1802 (e.g., extending through the core 1814) and into electrical parallel electrical communication with the two first oxygen evolution electrodes 1811 and the two second oxygen evolution electrodes 1813. Still further, or instead, the electrochemical cell 1800 may include a third terminal 1823 extending through the vessel 1803 (e.g., extending through the core 1814) and into electrical communication with the GDE 1808. Thus, as may be appreciated from this example, each electrochemical stack in the electrochemical cell 1800 may be connected to external circuitry using only three terminals (e.g., the first terminal 1821, the second terminal 1822, and the third terminal 1823), as may be useful for ease of installment of the electrochemical cell 1800 while also providing cost and weight savings relative to an architecture requiring a larger number of terminals. Further, or instead, any one or more of the first terminal 1821, the second terminal 1822, or the third terminal 1823 may be nickel-plated, as may be useful for achieving high electrical conductivity with cost-effective use of material.

Alkaline batteries are generally prone to electrochemical creep that may cause seals to fail, resulting in electrolyte migration through microscopic cracks between the terminal and the sealing insulator. In turn, this may lead to reliability and safety issues. Thus, in general, each of the first terminal 1821, the second terminal 1822, or the third terminal 1823 may be overmolded with a seal that resists failure resulting from electrochemical creep. For the sake of efficient description, a seal around the first terminal 1821 is described below. Unless otherwise specified or made clear from the context, it shall be appreciated that the seal of the first terminal 1821 may be used with the second terminal 1822 and/or the third terminal 1823 without departing from the scope of the present disclosure.

The vessel 1803 may include the first terminal 1821 and a seal 1901. The first terminal 1821 may be connectable to an external circuit for ease of installation of the electrochemical cell 1800 as part of a larger module and/or as part of an end-use application. The seal 1901 may be overmolded on the first terminal 1821 and may be formed of a first polymer. For example, the first polymer may be a polyamide (e.g., nylon), which is useful for resisting degradation by an alkaline electrolyte. The core 1814 may be formed of a second polymer (different from the first polymer), such as a polymer that may be cost-effectively manufactured in injection molding while also accommodating the various strength and flexibility requirements of the vessel 1803. Examples of such polymers include one or more of acrylonitrile butadiene styrene (ABS), high-density polyethylene (HDPE), polypropylene, or a low-molecular weight polyamide. The seal 1901 may be molded into the core 1814 with the first terminal 1821 extending through the core 1814 into a ring 1824 defined by the core 1814 such that the first terminal 1821 may be connectable in electrical communication with the first anode 1810 and the second anode 1812, as described above. Thus, according to this example, it shall be appreciated with the core 1814 molded around the seal 1901 overmolded on the first terminal 182, the second polymer of the core 1814 may protect the polyamide of the seal 1901.

Having described various structural aspects of the electrochemical cell 1800 that may contribute to improved energy density, robustness, and manufacturability, attention is now directed to description of a method of assembly the electrochemical cell 1800.

The GDE 1808 may be secured to the core 1814 in a position with the GDE 1808 within the ring 1824 collectively formed by sides of the core 1814. In this context, securing the GDE 1808 to the core 1814 may include positioning the GDE 1808 in place within the ring 1824 and further, or instead, may include passing fluidic and/or electrical connections through the core 1814 from the GDE 1808 within the ring 1824. Advantageously, the core 1814 may be flexible prior to sealing the first panel 1816 and the second panel 1818 to the core 1814. That is, without the first panel 1816 or the second panel 1818 installed on the core 1814, the core 1814 may flex to accommodate dimensional variations and/or forces encountered during assembly of the electrochemical cell 1800. Thus, in some instances, securing the GDE 1808 to the core 1814 may include flexing the core 1814 prior to sealing the first panel 1816 and the second panel 1818 to the core.

At least one instance of an oxygen evolution electrode and at least one instance of an anode may be secured relative to the GDE 1808 secured to the core 1814. For example, the first module 1805 and the second module 1806 may be secured to the GDE 1808 secured to the core 1814, with the first module 1805 and the second module 1806 on opposite sides of the GDE 1808 within the core 1814. Again, in this context, securing the at least one instance of an oxygen evolution electrode and at least one instance of an anode relative to the GDE 1808 secured to the core 1814 may include passing one or more electrical connections through the core 1814 from the at least one oxygen evolution electrode and from the at least one anode (e.g., from one or both of the first module 1805 or the second module 1806). For example, the core 1814 may include the first terminal 1821 and the second terminal 1822 and passing the one or more electrical connections through the core 1814 may include electrically connecting the at least one anode (e.g., in the first module 1805 and/or in the second module 1806) to the first terminal 1821 and connecting at least one OEE (e.g., in the first module 1805 and/or in the second module 1806) to the second terminal 1822.

While the at least one oxygen evolution electrode and the at least one anode may be secured relative to the GDE 1808 to a portion of the vessel 1803 that is not the core 1814, it shall be appreciated that it may be useful to secure the at least one oxygen evolution electrode and the at least one anode to the core 1814 to achieve reliable relative spacing of these components relative to each other and relative to the GDE 1808. Thus, for example, in instances in which the at least one oxygen evolution electrode and the at least one anode are part of the first module 1805 and the second module 1806, each of the first module 1805 and the second module 1806 may be secured to the core 1814 to facilitate achieving reliable and accurate spacing from the GDE 1808 in a high throughput assembly process. In instances in which the at least one oxygen evolution electrode and the at least one anode are secured to the core 1814, such securement may include flexing the core 1814 prior to the first panel 1816 and the second panel 1818 being sealed to the core 1814. Stated differently, the core 1814 may flex to facilitate mounting various heavy and large electrodes relative to one another while achieving accurate positioning.

With the first module 1805, the second module 1806, and the GDE 1808 secured in the core 1814, the first panel 1816 and the second panel 1818 may each be sealed to the core 1814 such that the first panel 1816, the second panel 1818, and the core 1814 form the vessel 1803 enclosing the first module 1805, the second module 1806, and the GDE 1808. As an example, the first panel 1816, the second panel 1818, and the core 1814 may each be polymeric. As an example, the first panel 1816, the second panel 1818, and the core 1814 may each be acrylonitrile butadiene styrene (ABS). Alternatively, the first panel 1816, the second panel 1818, and the core 1814 may each be high density polyethylene (HDPE). Continuing with this example in which the first panel 1816, the second panel 1818, and the core 1814 are each polymeric, sealing the first panel 1816 and the second panel 1818 to the core 1814 may include welding the first panel 1816 and the second panel 1818 to the core 1814, as may be useful for cost-effectively achieving a robust and hermetic seal of the vessel 1803, as compared to other types of connections such as press-fitting. Examples of welding that may be used to seal the first panel 1816 and the second panel 1818 to the core 1814 include hot plate welding, infrared welding, ultraviolet welding, or laser welding. In certain instances, sealing the first panel 1816 and the second panel 1818 to the core 1814 may form tortuous fluid paths defined by the core 1814, the first panel 1816, and the second panel 1818.

While certain connections have been described as extending through a portion of the core 1814 toward the top of the electrochemical cell 1800, it shall be appreciated that the core 1814 may facilitate making connections along any portion of the core 1814. For example, the core 1814 may include overmolded pins that may extend through the core to facilitate alignment of the electrochemical cell 1800 in a module.

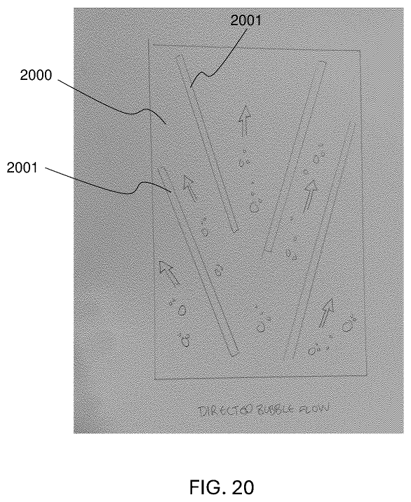

While the electrochemical cell 1800 may include certain features useful for managing the electrolyte within the electrochemical cell 1800, it shall be appreciated that additional or alternative aspects of electrolyte management are possible. For example, referring now to FIG. 20, a separator 2000 may have mounted thereon standoffs 2001 to facilitate maintaining spacing between any one or more of the oxygen evolution electrodes described herein relative any one or more of the anodes described herein. In general, an oxygen evolution electrode in a metal-air battery generates oxygen bubbles that need to travel upward through the spacing between the oxygen evolution electrode and an anode. If the bubble are unable to escape or are partially blocked, the bubbles will block electrolyte from making contact with the active area of the anode. Thus, in some instances, the standoffs 2001 may be angled to direct oxygen bubbles to outer Y-extends of the electrochemical cell, thus, reducing the likelihood of the oxygen bubbles interfering with the active area of the anode.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, “about” may refer to a range of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. An electrochemical cell comprising:
a vessel having a thickness dimension;
a first module including a first anode sandwiched between two first oxygen evolution electrodes along the thickness dimension of the vessel;
a second module including a second anode sandwiched between two second oxygen evolution electrodes along the thickness dimension of the vessel; and
a gas diffusion electrode (GDE) disposed between the first module and the second module in the vessel along the thickness dimension of the vessel.

2. The electrochemical cell of claim 1, wherein the vessel includes a core, a first panel, and a second panel collectively encapsulating the first module, the second module, and the GDE.

3. The electrochemical cell of claim 2, wherein the first panel and the second panel are each welded to the core.

4. The electrochemical cell of claim 2, wherein the first module, the second module, and the GDE are each supported in place by the core of the vessel alone.

5. The electrochemical cell of claim 2, wherein all fluid ports into the vessel and all electrical connections into the vessel pass through the core of the vessel.

6. The electrochemical cell of claim 1, wherein the first anode and the second anode are load-bearing members within the vessel.

7. The electrochemical cell of claim 1, wherein, in the first module, the each of the two first oxygen evolution electrodes is heat staked to the first anode and, in the second module, each of the two second oxygen evolution electrodes is heat staked to the second anode.

8. The electrochemical cell of claim 1, further comprising a first terminal extending through the vessel and into parallel electrical communication with the first anode and the second anode in the vessel.

9. The electrochemical cell of claim 8, further comprising a second terminal extending through the vessel and into parallel electrical communication with the two first oxygen evolution electrodes and the two second oxygen evolution electrodes.

10. The electrochemical cell of claim 9, further comprising a third terminal extending through the vessel and into electrical communication with the GDE.

11. The electrochemical cell of claim 10, further comprising a polyamide seal overmolded on at least one of the first terminal, the second terminal, or the third terminal.

12. A vessel for an electrochemical cell, the vessel comprising:
a terminal electrically connectable to an external circuit;
a seal overmolded on the terminal, the seal formed of a first polymer, the first polymer being a polyamide; and
a core defining a ring, the core formed of a second polymer different from the first polymer, and the seal molded into the core with the terminal extending through the core into the ring such that the terminal is connectable in electrical communication with one or more electrodes supportable in the ring.

13. The vessel of claim 12, wherein the terminal is a nickel-plated.

14. The vessel of claim 12, wherein the polyamide of the first polymer is nylon.

15. The vessel of claim 12, wherein the second polymer of the core is one or more of acrylonitrile butadiene styrene (ABS), high-density polyethylene (HDPE), polypropylene, or a low-molecular weight polyamide.

16. A method of assembling an electrochemical cell, the method comprising:
securing a gas diffusion electrode (GDE) to a core in a position with the GDE within a ring collectively formed by sides of the core;
securing at least one oxygen evolution electrode (OEE) and at least one anode relative to the GDE secured to the core; and
sealing a first panel and a second panel to the core such that the first panel, the second panel, and the core enclose the GDE, the at least one OEE, and the at least one anode.

17. The method of claim 16, wherein securing the GDE to the core includes passing one or more electrical connections through the core from the GDE.

18. The method of claim 17, wherein securing the at least one oxygen evolution electrode (OEE) and the at least one anode relative to the GDE secured to the core includes passing one or more electrical connections through the core from the at least one OEE and from the at least one anode.

19. The method of claim 18, wherein the core includes one or more terminals and passing the one or more electrical connections through the core includes electrically connecting the at least one OEE, and the at least one anode to the one or more terminals.

20. The method of claim 16, wherein securing the at least one OEE and the at least one an anode relative to the GDE secured to the core includes securing an OEE on each side of the GDE secured to the core and securing an anode on each side of the GDE secured to the core.
